(19) United States
(12) Patent Application Publication
(10) Pub. No.: US 2023/0100157 A1
(43) Pub. Date: Mar. 30, 2023

(54) FAST ACTINICALLY CURABLE COMPOSITIONS FOR 3D COMPOSITES

(71) Applicants: Arkema France, Colombes (FR); Continuous Composites, Inc., Coeur d'Alene, ID (US)

(72) Inventors: Sean A. Nuñez, Barcelona (ES); Amelia Davenport, Broomfield, CO (US); Neil Brian Cramer, Boulder, CO (US)

(73) Assignees: Arkema France, Colombes (FR); Continuous Composites, Inc., Coeur d'Alene, ID (US)

(21) Appl. No.: 17/801,421

(22) PCT Filed: Feb. 25, 2021
(86) PCT No.: PCT/US2021/019603

§ 371 Date: Aug. 22, 2022

Related U.S. Application Data
(60) Provisional application No. 62/981,512, filed on Feb. 25, 2020.

(51) Int. Cl. C08F 222/10; C08F 2/50; C08J 5/04; B33Y 70/00; B33Y 10/00; B33Y 30/00

(52) U.S. Cl. CPC C08F 222/1065; C08F 2/50; C08J 5/042; B33Y 70/00; B33Y 10/00; B33Y 30/00; C08J 2333/14

(57) ABSTRACT

An actinically curable composition includes (a) at least one monomer of formula (I);

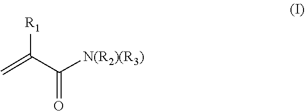

(b) at least one monomer of formula (II);

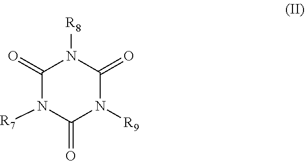

(c) optionally a urethane (meth)acrylate oligomer; and
(d) a photoinitiator,

wherein R₁, R₂, R₃, R₇, R₈ and R₉ are as defined. A method of making a three dimensionally printed composite article from the actinically curable composition is also provided.

### CROSS-REFERENCE TO RELATED APPLICATION

This application is a national phase application of PCT/US2021/019603, filed Feb. 25, 2021, which claims priority to U.S. Provisional Application No. 62/981,512, titled” FAST ACTINICALLY CURABLE COMPOSITIONS FOR 3D COMPOSITES″ filed Feb. 25, 2020 and the contents of which are incorporated herein by reference in their entireties for all purposes.

### FIELD OF THE INVENTION

The present disclosure relates generally to a composition (matrix) and, more particularly, to a composition for an additive manufacturing system, where the compositions are actinically curable compositions. In an embodiment, the actinically curable compositions include at least one monomer of formula (I), at least one monomer of formula (II), an optional urethane (meth)acrylate oligomer and a photoinitiator. The curable compositions may also include at least one monomer of formula (III) and one or more reinforcement materials.

The invention also relates to methods of making three dimensionally printed composite articles from the actinically curable compositions, optionally co-deposited with one or more reinforcement materials, using techniques that include stereolithography (SLA), digital light projection (DLP), binder jetting (BJ) or continuous fiber 3D (CF3D®) (Arrillaga et al., Additive Manufacturing 2021, 37, 101748).

### BACKGROUND OF THE INVENTION

Accelerated radical photopolymerization is typically achieved by increasing photoinitiator concentrations. However, such a strategy often leads to diminished material properties resulting from a decrease in molecular weight distributions, increased crosslinking events, discoloration, photodegradation of the cured product, and photoinitiator leaching. Other strategies toward increasing radical photopolymerization rates have been under investigation over the last few decades to identify and even design new ethynically-curable monomer and oligomers with fast innate polymerization rates.

Radical photopolymerization reactivities of fast-curing ethynically curable monomers and oligomers have been described as varying with their molecular structure using a variety of quantitative structure property relationships (Stansbury, J. Mol. Graph. Model. 2011, 29, 763-772). Several structure property relationships have been proposed with mixed results toward a comprehensive model of predicting photopolymerization kinetics of commercially available (meth)acrylates and (meth)acrylamides. For instance, Bowman found variable degrees of substitution at the alpha- and beta-positions of ethylene spacer within niche acrylates had profound effects on polymerization reactivity (Bowman, Macromolecules 2005, 3093-3098). Jansen reported an intriguing, but disputed, positive correlation between the maximum rate of polymerization and the Boltzmann-averaged dipole moment of ethynically-curable monomers and oligomer and mixtures thereof (Jansen, Macromolecules, 2002, 35, 7529-7531; Bowman, Polymer 2005, 4735-4742). It has also been reported, that the inclusion of heteroatomic sulfur in (meth)acrylate oligomers side groups increased reactivity (Andrzejewski, Polymer Chemistry 2000, 665-673) and more generally, heteroatom-rich polar side groups led to enhanced kinetic activity (Aviyente, Macromolecules 2007 40(26), 9560-9602).

Thus, it is evident that there exists a need for comprehensive rules to quickly identify fast-curing monomers and oligomers for specialized applications where such fast reactivities allow for time and cost savings, improved properties through reduced photoinitiator concentrations, and even enable new methods of manufacturing. Fast radical polymerizing monomers have been shown to exhibit extensive polymerization in dark conditions (up to 35% additional conversion after cessation of UV light) as compared to more traditional ethynically-curable monomers and oligomers (Bowman, Polymer (Guidf.) 2007, 48(7), 2014-2021). This added conversion is particularly beneficial in composite applications where opaque or high filler content obscures or scatters the penetration of light leading to an undesired reduced cure. Thus, the curation of fast radical polymerizing ethynically-curable monomers is particularly useful for resin formulations designed for non-optical structural composites such as fiberglass and carbon fiber. This invention is further beneficial in the context of additive manufacturing of reinforced structural composites where cure speed is needed to impart near immediate green strength to provide structural integrity for the three dimensional article.

The use of conventional compositions suitable for additive manufacturing systems that use actinic radiation to cure the compositions are challenging to produce and utilize due to the presence of opaque and light scattering reinforcement materials present in the composite composition that reduces the degree of cure. Accordingly, there remains a need for fast actinically curing compositions and more effective methods for producing them.

### SUMMARY OF THE INVENTION

One aspect of the present invention provides a curable composition.

In an embodiment, the curable composition is an actinically curable composition comprising (or alternatively, consisting of):
(a) 20 to 80 wt % of at least one (meth)acrylamide (i.e., an acrylamide or methacrylamide) satisfying the criteria of (1) having an average dipole moment of 2.5 or greater; (2) hydrogen or a methyl group or a methylene group at the alpha position to the nitrogen atom of the acrylamide or methacrylamide, and hydrogen, a methyl group, a methylene group, a methine group, a heteroatom or an aromatic group at the beta position to the nitrogen atom; and (3) two or more heteroatoms per molecule of the acrylamide or methacrylamide;
(b) 10 to 60 wt % of at least one monomer of formula (II);

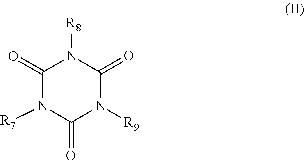

(c) 0-30 wt % of one or more urethane (meth)acrylate oligomers; and
(d) 0.1-5 wt % of one or more photoinitiators, wherein:
   R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂.
   R₁₀ is selected from the group consisting of H and C₁-C₃ alkyl; and
   n is 1, 2, 3 or 4.

In an embodiment, the curable composition includes an actinically curable composition comprising (or alternatively, consisting of):
(a) 20 to 80 wt % of at least one (meth)acrylamide monomer of formula (I);

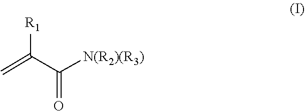

(b) 10 to 60 wt % of at least one monomer of formula (II);

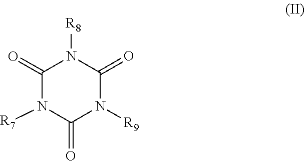

(c) 0-30 wt % of one or more urethane (meth)acrylate oligomers; and
(d) 0.1-5 wt % of one or more photoinitiators,
   wherein:
R₁ is H or C₁-C₃ alkyl;
R₂ and R₃ are each independently selected from the group consisting of H, C₁-C₃ alkyl, CH₂—CH(OH)C₁-C₃ alkyl and (CH₂)ₘX,
or R₂ and R₃ together with the nitrogen atom to which they are attached form a 3- to 6-membered saturated heterocyclic ring;
X is OR₄, SR₄, NR₅R₆, OP(═O)(OR₄)₂, CH₂P(═O)(OR₄)₂ or an aromatic group;
each R₄ is independently selected from the group consisting of H and C₁-C₄ alkyl;
R₅ and R₆ are each independently selected from the group consisting of H and C₁-C₃ alkyl;
m is 1, 2, 3, 4 or 5;
R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂;
R₁₀ is selected from the group consisting of H and C₁-C₃ alkyl; and
n is 1, 2, 3 or 4.

In an embodiment of the curable composition, R₁ is H, and R₂ and R₃ together with the nitrogen atom to which they are attached form a 5- or 6-membered saturated heterocyclic ring for the monomer of formula (I).

In a further embodiment of the curable composition, at least one of R₇, R₈ and R₉ is (CH₂)ₙO(C═O)—CR₁₀═CH₂ where n is 2 for the monomer of formula (II).

In a further embodiment of the curable composition, at least two of R₇, R₈ and R₉ is (CH₂)ₙO(C═O)—CR₁₀═CH₂ where n is 2 for the monomer of formula (II).

In a further embodiment of the curable composition, at least one of R₇, R₈ and R₉ is (CH₂)ₙO(C═O)—CR₁₀═CH₂ where n is 2 and R₁₀ is H for the monomer of formula (II).

In a further embodiment of the curable composition, at least two of R₇, R₈ and R₉ is (CH₂)ₙO(C═O)—CR₁₀═CH₂ where n is 2 and R₁₀ is H for the monomer of formula (II).

In an embodiment, the acrylamide/methacrylamide or the monomer of formula (I) is selected from the group consisting of:

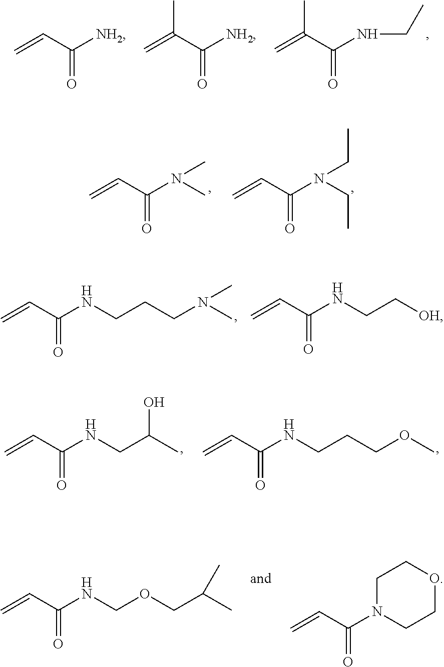

In an embodiment, the monomer of formula (I) is acryloyl morpholine (ACMO):

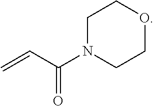

In an embodiment, the monomer of formula (II) is tris(2-hydroxyethyl)isocyanurate triacrylate (M370)(also referred to herein as SR368):

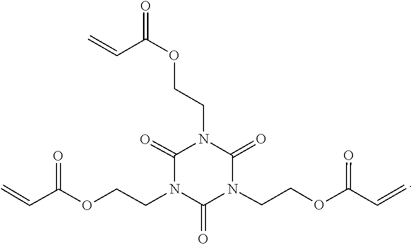 [SMILES: C=CC(=O)OCCn1c(=O)n(CCOC(=O)C=C)c(=O)n(CCOC(=O)C=C)c1=O]

In an embodiment of the curable composition, the monomer of formula (I) is ACMO:

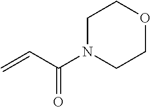

and the monomer of formula (II) is M370:

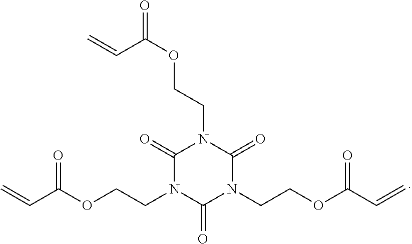 [SMILES: C=CC(=O)OCCn1c(=O)n(CCOC(=O)C=C)c(=O)n(CCOC(=O)C=C)c1=O]

In an embodiment, the curable composition comprises (or alternatively, consists of) ACMO, M370 and a photoinitiator.

In an embodiment, the curable composition comprises (or alternatively, consists of) ACMO, M370, a urethane (meth)acrylate oligomer and a photoinitiator.

In an embodiment, the curable composition further comprises a reinforcement material (filler).

In an embodiment, the curable composition comprises (or alternatively, consists of) ACMO, M370, a reinforcement material and a photoinitiator.

In an embodiment, the curable composition comprises (or alternatively, consists of) ACMO, M370, a urethane (meth)acrylate oligomer, a reinforcement material and a photoinitiator.

In a further embodiment, the reinforcement material is an opaque reinforcement material (opaque filler) or a light scattering reinforcement material (light scattering filler).

In an embodiment, the reinforcement material is selected from the group consisting of glass fibers, fiberglass, chopped carbon fibers, continuous carbon fibers, Kevlar fibers, ceramic fibers, asbestos, polybenzimidazole fibers, polysulforamide fibers, poly(phenylene oxide fibers, vegetable fibers, wood fibers, mineral fibers, plastic fibers, metallic wires and aramid fibers, optionally in the presence of one or more of nylon, polylactic acid (PLA), acrylonitrile butadiene styrene (ABS), polyethylene terephthalate glycol (PETG) and polycarbonate.

In an embodiment, the reinforcement material is not glass fibers.

In an embodiment, the reinforcement material is fiberglass or continuous carbon fibers.

In an embodiment, the urethane (meth)acrylate oligomer is selected from the group consisting of a polyurethane (meth)acrylate oligomer (commercially available as SARTOMER® CN989 (PHOTOMER® 6008), SARTOMER® CN9005 (PHOTOMER® 6010), SARTOMER® CN964 (PHOTOMER® 6019), SARTOMER® CN989 (PHOTOMER® 6184), PHOTOMER® 6630, SARTOMER® CN929 (PHOTOMER® 6892), SARTOMER® CN963, SARTOMER® CN945, SARTOMER® CN944, SARTOMER® CN989, SARTOMER® CN959 and SARTOMER® CN981.

In an embodiment, the photoinitiator is selected from the group consisting of benzophenones, benzoin ethers, benzyl ketals, α-hydroxyalkylphenones, α-alkoxyalkylphenones, α-aminoalkylphenones and acylphosphine (oxides).

In an embodiment, the photoinitiator is selected from the group consisting of 1-hydroxy-cyclohexyl-phenyl-ketone (IRGACURE® IC-184); 2,4,6-trimethylbenzoyldiphenylphosphine oxide (LUCIRIN® TPO); 2,4,6-trimethylbenzoylethoxyphenylphosphine oxide (LUCIRIN® TPO-L); bis(2,4,6-trimethylbenzoyl)-phenyl-phosphine oxide (IRGACURE® 819); 2-methyl-1-(4-methylthio)phenyl-2-(4-morpholinyl)-1-propanone (IRGACURE® 907) and 1-(4-(2-hydroxyethoxy)phenyl)-2-hydroxy-2-methylpropan-1-one (IRGACURE® 2959); 2-benzyl 2-dimethylamino 1-(4-morpholinophenyl)-butanone-1 (IRGACURE® 369); 2-hydroxy-1-(4-(4-(2-hydroxy-2-methylpropionyl)-benzyl)-phenyl)-2-methylpropan-1-one (IRGACURE® 127); and 2-dimethylamino-2-(4-methylbenzyl)-1-(4-morpholin-4-yl-phenyl)-butan-1-one (IRGACURE® 379).

In an embodiment, the curable composition further comprises a (meth)acrylate (i.e., an acrylate or methacrylate) satisfying the criteria of (1) having an average dipole moment of 2.5 or greater; (2) methyl or methylene at the alpha position to the oxygen atom of the acrylate or methacrylate and hydrogen, methyl, methylene, methine, heteroatom or aromatic at the beta position to the oxygen atom; and (3) three or more heteroatoms per acrylate molecule and four or more heteroatoms per methacrylate molecule.

In an embodiment, the curable composition further comprises 1 to 30 wt % a (meth)acrylate (i.e., an acrylate or a methacrylate) monomer of formula (III)

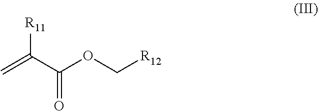

wherein:

each R₁₁ is independently H or C₁-C₃ alkyl; and

R₁₂ is selected from the group consisting of:
a 3- to 7-membered heterocyclic ring containing at least one of N, O or S when Ru is H and a 4- to 7-membered heterocyclic ring containing at least two of N, O or S when Ru is C₁-C₃ alkyl;
an optionally branched C₂-C₁₀ alkane chain wherein at least one carbon atom of the alkane chain is replaced by N, O, S or P when Ru is H, the alkane chain terminating in a C₁-C₃ alkyl group and where the optional branching group is a C₁-C₃ alkyl group;
an optionally branched C₃-C₁₀ alkane chain wherein at least two carbon atoms of the alkane chain is replaced by N, O, S or P when Ru is C₁-C₃ alkyl, the alkane chain terminating in a C₁-C₃ alkyl group and where the optional branching group is a C₁-C₃ alkyl group; and
an optionally branched C₂-C₂₀ alkane chain wherein one or more carbon atoms of the alkane chain are optionally replaced by N, O, S or P, the alkane chain terminating in a acrylate group (—O—C(═O)—CH═CH₂) or a methacrylate group (—O—C(═O)—C(CH₃)═CH₂) and where the optional branching group is a C₁-C₃ alkyl group.

In embodiments of the acrylate monomer of formula (III), R₁₁ is H and R₁₂ is selected from the group consisting of:

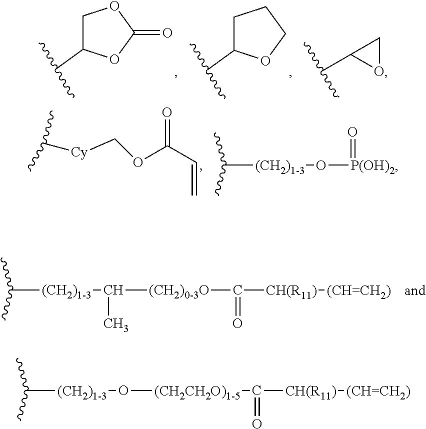

where Cy is a cycloalkyl group having 3 to 7 ring carbons (which includes cyclopropyl, cyclobutyl, cyclopentyl, cyclohexyl and cycloheptyl).

In embodiments of the monomer of formula (III), R₁₁ is a C₁-C₃ alkyl group and R₁₂ is selected from the group consisting of:

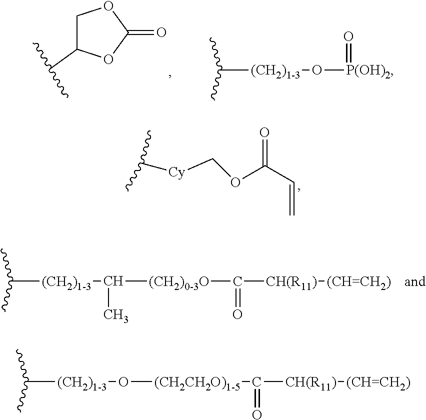

where Cy is a cycloalkyl group having 3 to 7 ring carbons (which includes cyclopropyl, cyclobutyl, cyclopentyl, cyclohexyl and cycloheptyl).

In an embodiment, the curable composition comprises (or alternatively, consists of) ACMO, M370, a (meth)acrylate monomer of formula (III) and a photoinitiator.

In an embodiment, the curable composition comprises (or alternatively, consists of) ACMO, M370, a (meth)acrylate monomer of formula (III), a urethane (meth)acrylate oligomer and a photoinitiator.

In an embodiment, the curable composition comprises (or alternatively, consists of) ACMO, M370, a (meth)acrylate monomer of formula (III), a reinforcement material and a photoinitiator.

In an embodiment, the curable composition comprises (or alternatively, consists of) ACMO, M370, a (meth)acrylate monomer of formula (III), a urethane (meth)acrylate oligomer, a reinforcement material and a photoinitiator.

In an embodiment, the curable composition comprises (or alternatively, consists of):
20-80 wt % ACMO as monomer (I);
10-60 wt % M370 as monomer (II);
0-30 wt % PHOTOMER® 6019 as a coating agent; and
0.1-5 wt % IRGACURE® 819 as a photoinitiator.

In an embodiment, the curable composition comprises:
20-50 wt % ACMO as monomer (I);
30-60 wt % M370 as monomer (II);
5-20 wt % PHOTOMER® 6019 as a coating agent; and
1-5 wt % IRGACURE® 819 as a photoinitiator.

In an embodiment, the curable composition comprises (or alternatively, consists of):
20-80 wt % ACMO as monomer (I);
10-60 wt % M370 as monomer (II);
0-30 wt % PHOTOMER® 6019 as a coating agent;
0.1-5 wt % IRGACURE® 819 as a photoinitiator; and
a reinforcement material.

In an embodiment, the curable composition comprises:
20-50 wt % ACMO as monomer (I);
30-60 wt % M370 as monomer (II);
5-20 wt % PHOTOMER® 6019 as a coating agent;
1-5 wt % IRGACURE® 819 as a photoinitiator; and
a reinforcement material.

In an embodiment, the curable composition comprises:
28.8 wt % ACMO as monomer (I);
52.9 wt % M370 as monomer (II);
14.4 wt % PHOTOMER® 6019 as the coating agent; and
3.8 wt % IRGACURE® 819 as the photoinitiator.

In an aspect, the curable composition as described herein is 3D printable.

A further aspect is a structure comprising:
an opaque or light scattering reinforcement material; and
a curable composition (matrix) as described herein at least partially coating the opaque or light scattering reinforcement material.

In an embodiment, the structure comprises:
an opaque or light scattering reinforcement material; and
a curable composition (matrix) at least partially coating the opaque or light scattering reinforcement material, the composition comprising:
20-80 wt % ACMO;
10-60 wt % M370;
0-30 wt % PHOTOMER® 6019; and
0.1-5 wt % IRGACURE® 819.

In an embodiment, the composition comprises:
28.8 wt % ACMO;
52.9 wt % M370;
14.4 wt % PHOTOMER® 6019; and
3.8 wt % IRGACURE® 819.

A further aspect is a method for curing the curable composition comprising subjecting the curable composition described herein to actinic radiation sufficient to cure the curable composition. In an embodiment, the curable composition further comprises a reinforcement material.

A further aspect is a structure fabricated by an additive manufacturing system, where the structure includes a reinforcement material and a composition (matrix) at least partially coating the reinforcement material, and where the composition comprises ACMO; M370; PHOTOMER® 6019; and IRGACURE® 819.

An embodiment is a structure fabricated by an additive manufacturing system, where the structure includes an opaque reinforcement, and a composition (matrix) at least partially coating the opaque reinforcement, and where the composition (matrix) comprises 20-80 wt % ACMO; 10-60 wt % M370; 0-30 wt % PHOTOMER® 6019; and 0.1-5 wt % IRGACURE® 819.

A further aspect is a method of making a three dimensionally printed composite article comprising:
discharging the actinically curable composition as described herein from a print head, the actinically curable composition including a reinforcement material;
moving the print head during discharging the actinically curable composition; and
irradiating the actinically curable composition to form a cured three dimensionally printed composite article.

A further aspect is a method of making a three dimensionally printed carbon bonded composite article using continuous fiber 3D (CF3D®), comprising:
irradiating the actinically curable composition as described herein in the presence of continuous carbon fibers to form a cured three dimensionally printed carbon bonded composite article.

In an embodiment, the curable composition is applied as a single deposition.

In an embodiment, the cured composite article has low optical transparency or scatters light.

A further aspect is a print head containing the curable composition as described herein.

### BRIEF DESCRIPTION OF THE DRAWINGS

The figures are reflective of particular embodiments of the invention and are not intended to otherwise limit the scope of the invention as described herein.

FIG. 1 is a diagrammatic illustration of an exemplary additive manufacturing system.

FIG. 2 is a chart depicting the analysis results of a composition (matrix) suitable for use with the additive manufacturing system of FIG. 1.

### DETAILED DESCRIPTION OF THE INVENTION

Accelerated radical photopolymerization is typically achieved by increasing photoinitiator concentrations, although other methods for accelerating radical photopolymerization include increasing photoinitiator concentrations, irradiation intensity or utilizing an inert blanket such as nitrogen or argon. There are limited returns in terms of accelerating polymerization for all of these methods. In the case of continuous composites, one objective of the present invention is to employ a high irradiation intensity. To accomplish this objective, new “fast” monomers were necessary. This invention is directed to actinic radiation-curable resin compositions for additive manufacturing of 3D printed materials, where the compositions contain fast-curing monomers (also referred to herein as fast monomers). To facilitate identification of the acrylamide and acrylate monomers that may qualify as fast-curing monomers for suitable inclusion in the actinic radiation-curable compositions described herein, the inventors developed a tripartite set of requirements based on “functional group substitution”, “Boltzmann average dipole moment” and “number of heteroatoms per molecule”. These three requirements are referred to collectively as the “three-prong test” and include the “substitution prong”, the “average dipole moment prong” and the “heteroatom per molecule” prong.

### Substitution Prong

The “substitution” prong of the three-prong test is based on the observation that for (meth)acrylates, it is preferred that the alpha-position to the oxygen atom of the ester functionality is a methyl group (—CH₃) or a methylene group (—CH₂—), and the beta-position is hydrogen, a methyl group (—CH₃), a methylene group (—CH₂—), a methine group (—CH—), a heteroatom or an aromatic group. As used herein, the term “(meth)acrylate” refers to both acrylate (—O—C(═O)—CH═CH₂) as well as methacrylate (—O—C(═O)—C(CH₃)═CH₂) compounds. For (meth)acrylamides, it is preferred that the alpha-position is unsubstituted, a methyl group (—CH₃) or a methylene group (—CH₂—), and the beta-position is hydrogen, a methyl group (—CH₃), a methylene group (—CH₂—), a methine group

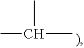

a heteroatom or an aromatic group. As used herein, the term “(meth)acrylamide” refers to both acrylamide (—NR—C(═O)—CH═CH₂) and methacrylamide (—NR—C(═O)—C(CH₃)═CH₂) compounds. These preferences are described as follows:

Substitution Reference:

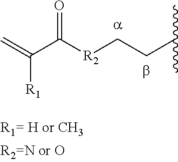

Rule: a (meth)acrylate wherein the alpha and beta positions to the oxygen of the ester comprise:
alpha=methyl or methylene
beta=methyl, methylene, methine, heteroatom, or aromatic

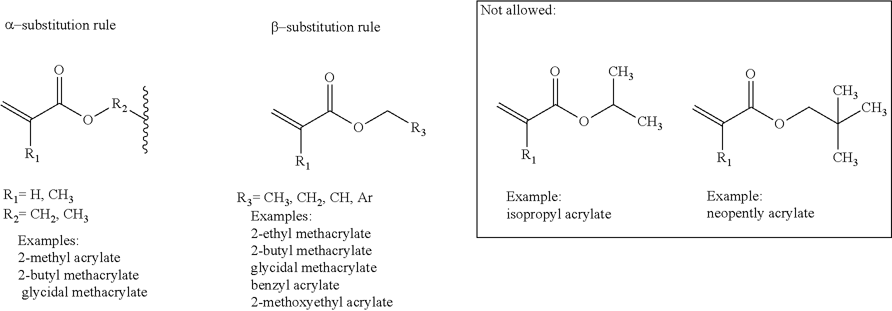

Rule: a (meth)acrylamide wherein the alpha and beta positions to the nitrogen of the amide comprise:
alpha=hydrogen, methyl or methylene
beta=hydrogen, methyl or methylene, methine, heteroatom, or aromatic

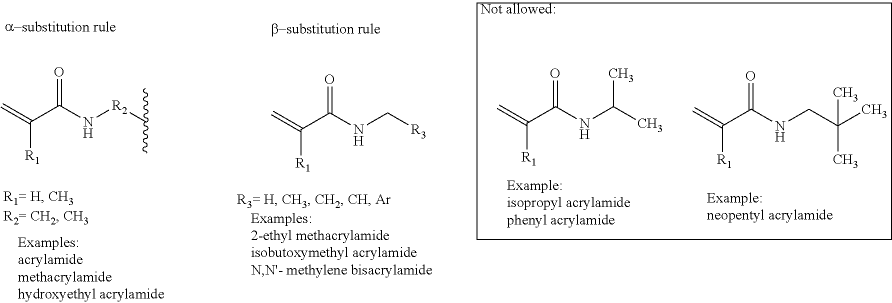

As defined for the substitution prong, “heteroatom” is N, O, S or P.

As defined for the substitution prong, “aromatic” is any aromatic carbocyclic moiety such as, but not limited to, phenyl or naphthyl, and any aromatic heterocyclic ring of 5 to 10 members and having at least one heteroatom selected from nitrogen, oxygen and sulfur, and containing at least 1 carbon atom, including, but not limited to, both mono and bicyclic ring systems. Representative aromatic heterocyclic compounds include, but are not limited to, furyl, benzofuranyl, thiophenyl, benzothiophenyl, pyrrolyl, indolyl, isoindolyl, azaindolyl, pyridyl, quinolinyl, isoquinolinyl, oxazolyl, isooxazolyl, benzoxazolyl, pyrazolyl, imidazolyl, benzimidazolyl, thiazolyl, benzothiazolyl, isothiazolyl, pyridazinyl, pyrimidinyl, pyrazinyl, triazinyl, cinnolinyl, phthalazinyl and quinazolinyl.

For multifunctional asymmetric molecules where one (meth)acrylate functionality may have the requisite substitution and the other does not, if one of the functional groups qualifies, so does the entire molecule, but it is not likely to quality under all facets of the three-prong test.

A generalized comparison of the photo-reactivity trends of acrylates and acrylamides is shown below:

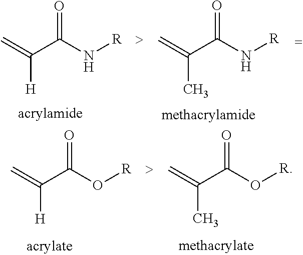

### Boltzmann Average Dipole Moment Prong

The “Boltzmann average dipole moment” prong of the tripartite requirement is based on the observation that for (meth)acrylates and (meth)acrylamides, it is preferred that the Boltzmann average dipole moment is 2.5 or greater, such as 2.6 or greater, such as 2.7 or greater, such as 2.8 or greater, such as 2.9 or greater, such as 3.0 or greater, such as 3.1 or greater, such as 3.2 or greater, such as 3.3 or greater. Exemplary ranges include 2.5 to 7.5, such as 2.5 to 7.0, such as 2.5 to 6.5, such as 2.5 to 6.0, such as 2.5 to 5.5, such as 2.5 to 5.0, 2.7 to 7.5, such as 2.7 to 7.0, such as 2.7 to 6.5, such as 2.7 to 6.0, such as 2.7 to 5.5, such as 2.7 to 5.0, such as 2.9 to 7.5, such as 2.9 to 7.0, such as 2.9 to 6.5, such as 2.9 to 6.0, such as 2.9 to 5.5, such as 2.9 to 5.0.

Calculation of the Boltmann average dipole moment is well known (C. Rowley, J. Chem. Phys. A 2014, 118, 3678-3687; US 20160068467 A1) and is determined herein by employing the following conventional methods: Wavefunction Spartan 18 Parallel Suite, Equilibrium Conformer, Density Functional, B97M-V, 6-311+G(2df,2p)(6-311G*), B3LYP and Global Calculations. Wavefunction Spartan 18 Parallel Suite is molecular modelling software used to determine molecular structure and calculate chemical properties used across industry and academia. Equilibrium Conformer specifies the lowest energy conformer of the molecule. Density Functional theory is a quantum mechanical modelling method used to calculate energies and wavefunctions of atoms and molecules containing many electrons. B97M-V is a specific density functional model. 6-311+G(2df,2p)(6-311G*) is a basis set, or set of functions that represent electronic wave functions to convert partial differential equations of the model into algebraic equations for efficient implementation on a computer. B3LYP is a density functional model used to calculate energies, wavefunctions, equilibrium and transition state geometries, and vibrational frequencies with a specified basis set. In Global Calculations, all atoms and molecules are calculated as specified. These methods are combined to provide the Boltzmann-weighted dipole moment of the equilibrium composition of the atom or molecule under examination. Notably, persons skilled in the art could employ alternative models that are widely accepted in academia and industry such as HF (Hartree-Fock), MP2 (Møller-Plesset), B3LYP hybrid functional theory or linear-response coupled cluster-singles and doubles calculations (LR-CCSD) and software to obtain similar values. The aforementioned combination method employed in this invention is preferred because it is considered rigorous by current standards and results in a high level of accuracy.

### Heteroatoms Per Molecule Prong

The “heteroatoms per molecule” prong of the three-prong requirement is based on the observation that for acrylates, it is preferred that there are 3 or more heteroatoms per molecule. For (meth)acrylates, it is preferred that there are 4 or more heteroatoms per molecule. For (meth)acrylamides, it is preferred that there are 2 or more heteroatoms per molecule. As defined for the heteroatoms per molecule prong, a “heteroatom” is N, O, S or P.

In an embodiment, the (meth)acrylate and (meth)acrylamide monomers must satisfy all three prongs to be considered as suitable for inclusion in the curable compositions of the present invention. In another embodiment, monomers satisfying two of the three prongs may also be considered as suitable for inclusion in the curable compositions of the present invention. In an embodiment, monomers satisfying at least the average dipole moment prong and the substitution prong are suitable for inclusion in the curable compositions. In another embodiment, monomers satisfying at least the average dipole moment prong and the heteroatom prong are suitable for inclusion in the curable compositions. Heteroatoms present in multifunctional (meth)acrylates receive no special treatment from the monofunctional components and as a result, the total number of heteroatoms in multifunctional (meth)acrylates are tallied as usual.

### Curable Composition

In an embodiment, the curable composition comprises:
(a) 20 to 80 wt % of at least one (meth)acrylamide (i.e., an acrylamide or methacrylamide) satisfying the criteria of (1) having an average dipole moment of 2.5 or greater or 2.7 or greater or 2.9 or greater or a range of 2.5 to 7.5 and including the ranges described herein for this prong; (2) hydrogen, methyl or methylene at the alpha position to the nitrogen atom of the acrylamide or methacrylamide and hydrogen, methyl, methylene, methine, heteroatom (N, O, S or P) or an aromatic group at the beta position to the nitrogen atom; and (3) two or more heteroatoms per molecule for the acrylamide or methacrylamide;
(b) 10 to 60 wt % of at least one monomer of formula (II);

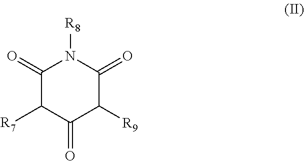

(c) 0-30 wt % of a urethane (meth)acrylate oligomer; and
(d) 0.1-5 wt % of a photoinitiator,
   wherein:

R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂.

R₁₀ is selected from the group consisting of H and C₁-C₃ alkyl; and

n is 1, 2, 3 or 4.

In an embodiment, the curable composition (in the absence of any reinforcement material) has a Tg of at least 80° C., such as at least 100° C., at least 150° C., such as at least 200° C., such as at least 80° C. to 230° C., such as at least 100° C. to 230° C., such as at least 150° C. to 230° C.

In another embodiment, the curable composition comprises:
(a) 20 to 80 wt % of at least one monomer of formula (I);

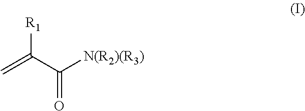

(b) 10 to 60 wt % of at least one monomer of formula (II);

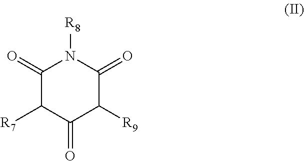

(c) 0-30 wt % of a urethane (meth)acrylate oligomer; and
(d) 0.1-5 wt % of a photoinitiator.

### For the Monomer of Formula (I) as Component (a):

R₁ is H or C₁-C₃ alkyl, where C₁-C₃ alkyl includes methyl, ethyl, propyl and isopropyl;

R₂ and R₃ are each independently selected from the group consisting of H, C₁-C₃ alkyl (where C₁-C₃ alkyl includes methyl, ethyl, propyl and isopropyl), CH₂—CH(OH)C₁-C₃ alkyl (where C₁-C₃ alkyl includes methyl, ethyl, propyl and isopropyl) and (CH₂)ₘX,

or R₂ and R₃ together with the nitrogen atom to which they are attached form a 3- to 6-membered saturated heterocyclic ring (where the 3- to 6-membered saturated heterocyclic ring is selected from the group consisting of aziridine, azetidine, pyrrolidine, imidazolidine, pyrazolidine, thiazolidine, isothiazolidine, piperidine, piperazine, morpholine and thiomorpholine);

X is OR₄, SR₄, NR₅R₆, OP(═O)(OR₄)₂, CH₂P(═O)(OR₄)₂ or an aromatic group;

R₄ is selected from the group consisting of H and C₁-C₄ alkyl (where C₁-C₄ alkyl includes methyl, ethyl, propyl, butyl, isopropyl and isobutyl);

R₅ and R₆ are each independently selected from the group consisting of H and C₁-C₃ alkyl (where C₁-C₃ alkyl is methyl, ethyl, propyl and isopropyl), or R₅ is H and R₆ is —NH—C(═O)—CH═CH₂ or —NH—C(═O)—C(CH₃)═CH₂; and

m is 1, 2, 3, 4 or 5.

In another embodiment of the monomer of formula (I) as component (a):

R₁ is H or methyl;

R₂ is H and R₃ is selected from the group consisting of H, methyl, CH₂—CH(OH)C₁-C₃ (where C₁-C₃ alkyl is methyl or ethyl) and (CH₂)ₘX;

or R₂ and R₃ together with the nitrogen atom to which they are attached form a 5- to 6-membered saturated heterocyclic ring (where the 5- to 6-membered saturated heterocyclic ring is selected from the group consisting of piperidine, piperazine, morpholine and thiomorpholine);

X is OR₄, SR₄, NR₅R₆ or an aromatic group;

R₄ is selected from the group consisting of H and C₁-C₄ alkyl (where C₁-C₄ alkyl includes methyl, ethyl, propyl, butyl, isopropyl and isobutyl);

R₅ and R₆ are each independently selected from the group consisting of H and C₁-C₃ alkyl (where C₁-C₃ alkyl includes methyl, ethyl, propyl and isopropyl), or R₅ is H and R₆ is —NH—C(═O)—CH═CH₂ or —NH—C(═O)—C(CH₃)═CH₂; and

m is 1, 2, 3, 4 or 5.

The monomer of formula (I) may be present in an amount of 20-80 wt % based on the total composition, such as 20 to 70 wt %, such as 20 to 60 wt %, such as 20 to 50 wt %, such as 20 to 40 wt %, such as 25 to 60 wt %, such as 25 to 50 wt %, such as 25 to 45 wt %, such as 30 to 60 wt %.

When the monomer of formula (I) is ACMO, the ACMO is present in an amount of 25 wt % or greater, such as 35 wt % or greater, such as 45 wt % or greater, such as 50 wt % or greater, with an upper limit of 80 wt %.

### For the Monomer of Formula (II) as Component (b):

R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂.

R₁₀ is selected from the group consisting of H and C₁-C₃ alkyl (where C₁-C₃ alkyl includes methyl, ethyl, propyl and isopropyl); and

n is 1, 2, 3 or 4.

In various embodiments:
one of R₇, R₈ and R₉ is (CH₂)ₙO(C═O)—CR₁₀═CH₂ where n is 1;
two of R₇, R₈ and R₉ is (CH₂)ₙO(C═O)—CR₁₀═CH₂ where n is 1;
all three of R₇, R₈ and R₉ is (CH₂)ₙO(C═O)—CR₁₀═CH₂ where n is 1;
one of R₇, R₈ and R₉ is (CH₂)ₙO(C═O)—CR₁₀═CH₂ where n is 2;
two of R₇, R₈ and R₉ is (CH₂)ₙO(C═O)—CR₁₀═CH₂ where n is 2;
all three of R₇, R₈ and R₉ is (CH₂)ₙO(C═O)—CR₁₀═CH₂ where n is 2;
one of R₇, R₈ and R₉ is (CH₂)ₙO(C═O)—CR₁₀═CH₂ where n is 3;
two of R₇, R₈ and R₉ is (CH₂)ₙO(C═O)—CR₁₀═CH₂ where n is 3;
all three of R₇, R₈ and R₉ is (CH₂)ₙO(C═O)—CR₁₀═CH₂ where n is 3;
one of R₇, R₈ and R₉ is (CH₂)ₙO(C═O)—CR₁₀═CH₂ where n is 4;
two of R₇, R₈ and R₉ is (CH₂)ₙO(C═O)—CR₁₀═CH₂ where n is 4;
all three of R₇, R₈ and R₉ is (CH₂)ₙO(C═O)—CR₁₀═CH₂ where n is 4;
one of R₇, R₈ and R₉ is (CH₂)ₙO(C═O)—CR₁₀═CH₂ where n is 1 and R₁₀ is H;
two of R₇, R₈ and R₉ is (CH₂)ₙO(C═O)—CR₁₀═CH₂ where n is 1 and R₁₀ is H;
all three of R₇, R₈ and R₉ is (CH₂)ₙO(C═O)—CR₁₀═CH₂ where n is 1 and R₁₀ is H.
one of R₇, R₈ and R₉ is (CH₂)ₙO(C═O)—CR₁₀═CH₂ where n is 2 and R₁₀ is H;
two of R₇, R₈ and R₉ is (CH₂)ₙO(C═O)—CR₁₀═CH₂ where n is 2 and R₁₀ is H;
all three of R₇, R₈ and R₉ is (CH₂)ₙO(C═O)—CR₁₀═CH₂ where n is 2 and R₁₀ is H;
one of R₇, R₈ and R₉ is (CH₂)ₙO(C═O)—CR₁₀═CH₂ where n is 3 and R₁₀ is H;
two of R₇, R₈ and R₉ is (CH₂)ₙO(C═O)—CR₁₀═CH₂ where n is 3 and R₁₀ is H;
all three of R₇, R₈ and R₉ is (CH₂)ₙO(C═O)—CR₁₀═CH₂ where n is 3 and R₁₀ is H;
one of R₇, R₈ and R₉ is (CH₂)ₙO(C═O)—CR₁₀═CH₂ where n is 4 and R₁₀ is H;
two of R₇, R₈ and R₉ is (CH₂)ₙO(C═O)—CR₁₀═CH₂ where n is 4 and R₁₀ is H;
all three of R₇, R₈ and R₉ is (CH₂)ₙO(C═O)—CR₁₀═CH₂ where n is 4 and R₁₀ is H;
one of R₇, R₈ and R₉ is (CH₂)ₙO(C═O)—CR₁₀═CH₂ where n is 1 and R₁₀ is CH₃;
two of R₇, R₈ and R₉ is (CH₂)ₙO(C═O)—CR₁₀═CH₂ where n is 1 and R₁₀ is CH₃;
all three of R₇, R₈ and R₉ is (CH₂)ₙO(C═O)—CR₁₀═CH₂ where n is 1 and R₁₀ is CH₃;
one of R₇, R₈ and R₉ is (CH₂)ₙO(C═O)—CR₁₀═CH₂ where n is 2 and R₁₀ is CH₃;
two of R₇, R₈ and R₉ is (CH₂)ₙO(C═O)—CR₁₀═CH₂ where n is 2 and R₁₀ is CH₃;
all three of R₇, R₈ and R₉ is (CH₂)ₙO(C═O)—CR₁₀═CH₂ where n is 2 and R₁₀ is CH₃;
one of R₇, R₈ and R₉ is (CH₂)ₙO(C═O)—CR₁₀═CH₂ where n is 3 and R₁₀ is CH₃;
two of R₇, R₈ and R₉ is (CH₂)ₙO(C═O)—CR₁₀═CH₂ where n is 3 and R₁₀ is CH₃;
all three of R₇, R₈ and R₉ is (CH₂)ₙO(C═O)—CR₁₀═CH₂ where n is 3 and R₁₀ is CH₃;
one of R₇, R₈ and R₉ is (CH₂)ₙO(C═O)—CR₁₀═CH₂ where n is 4 and R₁₀ is CH₃;
two of R₇, R₈ and R₉ is (CH₂)ₙO(C═O)—CR₁₀═CH₂ where n is 4 and R₁₀ is CH₃; or
all three of R₇, R₈ and R₉ is (CH₂)ₙO(C═O)—CR₁₀═CH₂ where n is 4 and R₁₀ is CH₃.

The monomer of formula (II) may be present in an amount of 10-60 wt % based on the total composition, such as 20 to 60 wt %, such as 20 to 50 wt %, such as 20 to 40 wt %, such as 25 to 60 wt %, such as 25 to 50 wt %, such as 25 to 45 wt %, such as 30 to 60 wt %.

### For the Optional Urethane (Meth)Acrylate Oligomer as Component (c):

Urethane (meth)acrylates (sometimes also referred to as “polyurethane (meth)acrylates”) capable of being used in the curable compositions of the present invention include urethanes based on aliphatic and/or aromatic polyester polyols, polyether polyols and polycarbonate polyols and aliphatic and/or aromatic polyester diisocyanates and polyether diisocyanates capped with (meth)acrylate end-groups.

In various embodiments, the urethane (meth)acrylates may be prepared by reacting aliphatic and/or aromatic polyisocyanates (e.g., diisocyanates, triisocyanates) with OH group terminated polyester polyols (including aromatic, aliphatic and mixed aliphatic/aromatic polyester polyols), polyether polyols, polycarbonate polyols, polycaprolactone polyols, polydimethysiloxane polyols, or polybutadiene polyols, or combinations thereof to form isocyanate-functionalized oligomers which are then reacted with hydroxyl-functionalized (meth)acrylates such as hydroxyethyl (meth)acrylate or hydroxypropyl (meth)acrylate to provide terminal (meth)acrylate groups. For example, the urethane (meth)acrylates may contain two, three, four or more (meth)acrylate functional groups per molecule. Other orders of addition may also be practiced to prepare the polyurethane (meth)acrylate, as is known in the art. For example, the hydroxyl-functionalized (meth)acrylate may be first reacted with a polyisocyanate to obtain an isocyanate-functionalized (meth)acrylate, which may then be reacted with an OH group terminated polyester polyol, polyether polyol, polycarbonate polyol, polycaprolactone polyol, polydimethysiloxane polyol, polybutadiene polyol, or a combination thereof. In yet another embodiment, a polyisocyanate may be first reacted with a polyol, including any of the aforementioned types of polyols, to obtain an isocyanate-functionalized polyol, which is thereafter reacted with a hydroxyl-functionalized (meth)acrylate to yield a polyurethane (meth)acrylate. Alternatively, all the components may be combined and reacted at the same time.

Any of the above-mentioned types of oligomers may be modified with amines or sulfides (e.g., thiols), following procedures known in the art. Such amine- and sulfide-modified oligomers may be prepared, for example, by reacting a relatively small portion (e.g., 2-15%) of the (meth)acrylate functional groups present in the base oligomer with an amine (e.g., a secondary amine) or a sulfide (e.g., a thiol), wherein the modifying compound adds to the carbon-carbon double bond of the (meth)acrylate in a Michael addition reaction.

Examples of suitable urethane oligomers include those commercially available from Henkel Corp. under the trade name PHOTOMER® (e.g., PHOTOMER® 6008, PHOTOMER® 6010, PHOTOMER® 6019, PHOTOMER® 6184, PHOTOMER® 6630 and PHOTOMER® 6892) and from UCB Radcure Inc. under the trade names EBECRYL® (e.g., EBECRYL® 220, 284, 4827, 4830, 6602, 8400 and 8402), RXO® (e.g., RXO® 1336), and RSX® (e.g., RSX® 3604, 89359, 92576). Other useful acrylated urethanes are commercially available from Sartomer Co. under the trade name SARTOMER® (e.g., SARTOMER® 9635, 9645, 9655, 963-B80, and 966-A80), and from Morton International under the trade name UVITHANE® (e.g., UVITHANE® 782). Alternatively, conventional urethane acrylate oligomers may be formed by reacting a polyol, for example a diol, with a multifunctional isocyanate, for example a diisocyanate, and then end-capping with a hydroxy-functional (meth)acrylate. For the purpose of giving hardness to the cured film, the urethane oligomer preferably contains 3 or more (meth)acrylate groups, such as a urethane oligomer having 6 or more (meth)acrylate groups. The urethane oligomers may be used singly or as a mixture of two or more kinds.

The urethane oligomer may be present in an amount of 0-30 wt % based on the total composition, such as 1 to 25 wt %, such as 5 to 25 wt %, such as 5 to 20 wt %, such as 10 to 25 wt %, such as 10 to 20 wt %.

### For the Photoinitiator as Component (d):

In certain embodiments of the invention, the actinic radiation-curable compositions described herein include at least one photoinitiator and are curable with radiant energy (visible light, ultraviolet light). A photoinitiator may be considered any type of substance that, upon exposure to radiation (e.g., actinic radiation), forms species that initiate the desired reaction to cure the polymerizing organic substances present in the curable composition. Suitable photoinitiators include free radical photoinitiators.

Free radical polymerization initiators are substances that form free radicals when irradiated. The use of free radical photoinitiators is preferred.

Non-limiting examples include: phenylbis(2,4,6-trimethylbenzoyl)phosphine oxide) as photoinitiator. Non-limiting examples of suitable acylphosphine oxides include, but are not limited to, 2,4,6-trimethylbenzoyl-diphenyl-phosphine oxide, bis(2,4,6-trimethylbenzoyl)-phenyl phosphine oxide, bis(2,4,6-trimethylbenzoyl)-(2,4-bis-pentyloxyphenyl)phosphine oxide, and 2,4,6-trimethyl-benzoylethoxyphenylphosphine oxide and combinations thereof.

Non-limiting types of free radical photoinitiators suitable for use in the curable compositions of the present invention include, for example, benzoins, benzoin ethers, acetophenones, benzyl, benzyl ketals, anthraquinones, phosphine oxides, α-hydroxyketones, phenylglyoxylates, α-aminoketones, benzophenones, thioxanthones, xanthones, acridine derivatives, phenazene derivatives, quinoxaline derivatives and triazine compounds. Examples of particular suitable free radical photoinitiators include, but are not limited to, 2-methylanthraquinone, 2-ethylanthraquinone, 2-chloroanthraquinone, 2-benzyanthraquinone, 2-t-butylanthraquinone, 1,2-benzo-9,10-anthraquinone, benzyl, benzoins, benzoin ethers, benzoin, benzoin methyl ether, benzoin ethyl ether, benzoin isopropyl ether, alpha-methylbenzoin, alpha-phenylbenzoin, Michler's ketone, acetophenones such as 2,2-dialkoxybenzophenones and 1-hydroxyphenyl ketones, benzophenone, 4,4′-bis-(diethylamino) benzophenone, acetophenone, 2,2-diethyloxyacetophenone, diethyloxyacetophenone, 2-isopropylthioxanthone, thioxanthone, diethyl thioxanthone, 1,5-acetonaphthylene, ethyl-p-dimethylaminobenzoate, benzil ketone, α-hydroxy keto, 2,4,6-trimethylbenzoyldiphenyl phosphine oxide, benzyl dimethyl ketal, 2,2-dimethoxy-1,2-diphenylethanone, 1-hydroxycylclohexyl phenyl ketone, 2-methyl-1-[4-(methylthio) phenyl]-2-morpholinopropanone-1, 2-hydroxy-2-methyl-1-phenyl-propanone, oligomeric α-hydroxy ketone, benzoyl phosphine oxides, phenylbis(2,4,6-trimethylbenzoyl)phosphine oxide, ethyl-4-dimethylamino benzoate, ethyl(2,4,6-trimethylbenzoyl)phenyl phosphinate, anisoin, anthraquinone, anthraquinone-2-sulfonic acid, sodium salt monohydrate, (benzene) tricarbonylchromium, benzil, benzoin isobutyl ether, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, (cumene)cyclopentadienyl iron(ii) hexafluorophosphate, 9,10-diethoxy and 9,10-dibutoxyanthracene, 2-ethyl-9,10-dimethoxyanthracene, thioxanthen-9-one and combinations thereof.

In an embodiment, the photoinitiator is selected from the group consisting of 1-hydroxy-cyclohexyl-phenyl-ketone (IRGACURE® IC-184); 2,4,6-trimethylbenzoyldiphenylphosphine oxide (LUCIRIN® TPO); 2,4,6-trimethylbenzoylethoxyphenylphosphine oxide (LUCIRIN® TPO-L); bis(2,4,6-trimethylbenzoyl)-phenyl-phosphine oxide (IRGACURE® 819); 2-methyl-1-(4-methylthio)phenyl-2-(4-morpholinyl)-1-propanone (IRGACURE® 907) and 1-(4-(2-hydroxyethoxy)phenyl)-2-hydroxy-2-methylpropan-1-one (IRGACURE® 2959); 2-benzyl 2-dimethylamino 1-(4-morpholinophenyl)-butanone-1 (IRGACURE® 369); 2-hydroxy-1-(4-(4-(2-hydroxy-2-methylpropionyl)-benzyl)-phenyl)-2-methylpropan-1-one (IRGACURE® 127); and 2-dimethylamino-2-(4-methylbenzyl)-1-(4-morpholin-4-yl-phenyl)-butan-1-one (IRGACURE® 379).

The photoinitiator may be present in an amount of 0.1-5 wt % based on the total composition, such as 0.5 to 5 wt %, such as 1 to 5 wt %, such as 2 to 5 wt %.

### Optional Monomer of Formula (III)

In an embodiment of the invention, the curable resin comprises at least one (meth)acrylate (i.e., an acrylate or methacrylate) monomer in addition to the components (a), (b), (d) and optionally (c) as described herein, wherein the acrylate or methacrylate monomer satisfies the criteria of (1) having an average dipole moment of 2.5 or greater or 2.7 or greater or 2.9 or greater or a range of 2.5 to 7.5 and including the ranges described herein for this prong; (2) methyl or methylene at the alpha position to the oxygen atom of the acrylate or methacrylate and hydrogen, methyl, methylene, methine, heteroatom (N, O, S or P) or an aromatic group at the beta position to the oxygen atom; and (3) three or more heteroatoms per molecule for the acrylate and four or more heteroatoms per molecule for the methacrylate.

In another embodiment of the invention, the curable resin comprises at least one monomer of formula (III) in addition to the components (a), (b), (d) and optionally (c) as described herein.

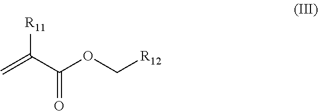

wherein:

each R₁₁ is independently H or C₁-C₃ alkyl (where C₁-C₃ alkyl is methyl, ethyl, propyl or isopropyl); and

R₁₂ is selected from the group consisting of:
a 3- to 7-membered heterocyclic ring containing at least one of N, O or S when Ru is H and a 4- to 7-membered heterocyclic ring containing at least two of N, O or S when Ru is C₁-C₃ alkyl;
an optionally branched C₂-C₁₀ alkane chain wherein at least one carbon atom of the alkane chain is replaced by N, O, S or P when Ru is H, the alkane chain terminating in a C₁-C₃ alkyl group and where the optional branching group is a C₁-C₃ alkyl group;
an optionally branched C₃-C₁₀ alkane chain wherein at least two carbon atoms of the alkane chain is replaced by N, O, S or P when Ru is C₁-C₃ alkyl, the alkane chain terminating in a C₁-C₃ alkyl group and where the optional branching group is a C₁-C₃ alkyl group; and
an optionally branched C₂-C₂₀ alkane chain wherein one or more carbon atoms of the alkane chain are optionally replaced by N, O, S or P, the alkane chain terminating in a acrylate group (—O—C(═O)—CH═CH₂) or a methacrylate group (—O—C(═O)—C(CH₃)═CH₂) and where the optional branching group is a C₁-C₃ alkyl group.

In embodiments of the monomer of formula (III), R₁₁ is H and R₁₂ is selected from the group consisting of:

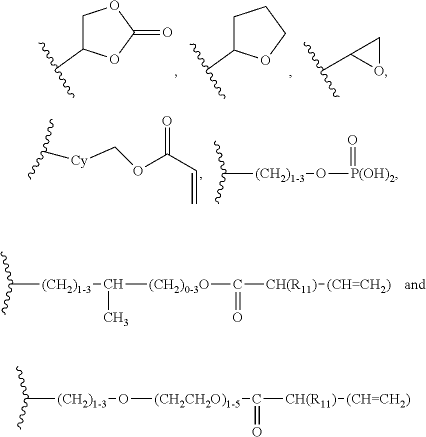

where Cy is a cycloalkyl group having 3 to 7 ring carbons.

In embodiments of the monomer of formula (III), R₁₁ is a C₁-C₃ alkyl group and R₁₂ is selected from the group consisting of:

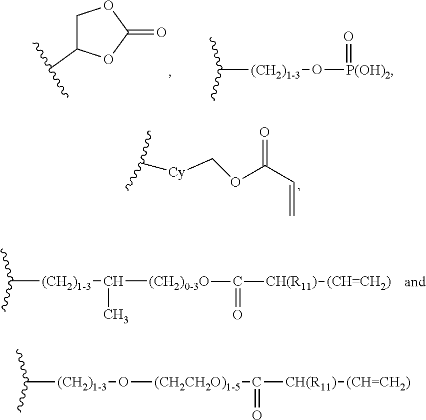

where Cy is a cycloalkyl group having 3 to 7 ring carbons (which includes cyclopropyl, cyclobutyl, cyclopentyl, cyclohexyl and cycloheptyl).

The monomer of formula (III) may be present in an amount of 1-30 wt % based on the total composition, such as 1 to 25 wt %, such as 5 to 25 wt %, such as 5 to 20 wt %, such as 10 to 25 wt %, such as 10 to 20 wt %.

### Reinforcement Material

The reinforcement material (also referred to as filler) is not particularly limited and may include, for example, carbon fibers, vegetable fibers, wood fibers, mineral fibers, glass fibers, metallic wires, etc. It should be noted that the phrase “reinforcement materials” is meant to encompass both structural and non-structural types of materials.

In an embodiment, the reinforcement material is opaque, where the term “opaque” as used herein in reference to the reinforcement material should be understood to mean a material which blocks all or substantially all radiation across the UV and visible wavelengths. In another embodiment, the reinforcement material is light scattering.

Those skilled in the art will recognize that, depending upon such factors as physical form or method of synthesis, certain fillers may be either UV opaque or UV transparent. Mixtures of more than one filler are within the scope of the invention, including embodiments of the invention having some opaque and some transparent fillers and/or some partially transparent fillers. Those skilled in the art will recognize that, depending upon such factors as physical form or method of synthesis, certain fillers may be either UV opaque or UV transparent or be partially UV transparent. Mixtures of more than one filler are within the scope of the invention.

Exemplary opaque fillers include chopped, or continuous carbon fibers available in any conventional form such as tow, braided, unidirectional, woven fabric, knitted fabric, swirl fabric, felt mat, wound, and the like. Such carbon fiber is usually based on polyacrylonitrile or pitch-type

The carbon fiber may be surface treated with plasma, nitric acid or nitrous acid or similar strong acids, and/or further surface functionalized (often referred to as “sized” or “sizing”) with agents such as but not limited to dialdehydes, epoxies, vinyl and other functional groups that would enhance adhesion of the carbon fiber to the cured polymer matrix.

Non-limiting examples of other UV opaque fillers may include carbon black, graphite, graphite felt, graphite foam, graphene, resorcinol-formaldehyde blends, polyacrylonitrile, rayon, petroleum pitch, natural pitch, resoles, carbon nanotubes, carbon soot, creosote, SiC, boron, WC, butyl rubber, boron nitride, fumed silica, nanoclay, silicon carbide, boron nitride, zirconium oxide, titanium dioxide, chalk, calcium sulfate, barium sulfate, calcium carbonate, silicates such as talc, mica or kaolin, silicas, aluminum hydroxide, magnesium hydroxide, or organic fillers such as polymer powders, polymer fibers, or the like, and mixtures thereof.

The reinforcement material may include or consist of continuous fiber. As used herein, continuous means having an aspect ratio (V) defined as length I divided by diameter d (l/d) greater than 100, 100, 3500, 1,000,000 or even larger. The reinforcement material may include chopped fiber, i.e. having an aspect ratio smaller than that of the continuous fiber and may be of any suitable shape or form. For example, the reinforcement material may take the form of powder, beads, microspheres, particles, granules, wires, fibers or combinations thereof. If in particulate form, the particles may be spheroid, flat, irregular or elongated in shape. High aspect particulate materials may be utilized, for example. Hollow as well as solid materials are useful in the present invention. According to various embodiments of the invention, the material may have an aspect ratio (i.e., the ratio of the length of an individual filler element, such as a particle or fiber, to the width of that individual filler element) of 1:1 or higher, e.g., greater than 1:1, at least 2:1, at least 3:1, at least 5:1, at least 10:1, at least 100:1, at least 1000:1; at least 10,000:1, at least 100,000:1, at least 500,000:1, at least 1,000,000:1 or even higher (i.e., effectively an infinite aspect ratio). According to other embodiments, the reinforcement material may have an aspect ratio not more than 2:1, not more than 3:1, not more than 5:1, not more than 10:1, not more than 100:1, not more than 1000:1; not more than 10,000:1, not more than 100,000:1, not more 500,000:1, or not more than 1,000,000:1.

The surface of the reinforcement material may be modified in accordance with any of the methods or techniques known in the art. Such surface treatment methods include, without limitation, sizing (e.g., coating with one or more organic substances), silylation, oxidation, functionalization, neutralization, acidification, other chemical modifications and the like and combinations thereof.

The chemical nature of the reinforcement material may be varied and selected as may be desired in order to impart certain properties or characteristics to the product obtained upon curing the light-curable composition. For example, the material may be inorganic or organic in character. Mixed organic/inorganic reinforcement materials may also be used. Carbon-based reinforcement materials (e.g., carbon fibers, carbon black, carbon nanotubes) as well as mineral materials can be employed.

The reinforcement material may include carbon fibers, glass fibers, fiberglass, natural fiber (kenaf fiber), twaron fibers, Dyneema fibers, ceramic fibers, asbestos, Kevlar fibers, polybenzimidazole fibers, polysulfonamide fibers, poly(phenylene oxide) fibers, vegetable fibers, wood fibers, mineral fibers, plastic fibers, metallic wires and/or aramid fibers. Carbon fiber is preferred and continuous carbon fiber is most preferred. Carbon fiber or other fiber(s) may be surface treated (plasma) or “sized” with an appropriate coupling agent such as nitric acid, glutaric dialdehyde or silanes for example. Carbon fibers, polyacrylonitrile fibers, or rayon fibers may be straight or woven and vary in fiber diameter and density. The fibers or co-fibers may have a varied fiber-volume-fractions from 20-90%, such as 25 to 80%, such as 30 to 75%, such as 30 to 70%. Mixtures of fibers, whether continuous or chopped are contemplated. For example, carbon fibers may be commodified with ceramic fibers, asbestos fibers, Kevlar fibers, polybenzimidazole fibers, polysulfonamide fibers, glass fibers, vegetable fibers, wood fibers, mineral fibers, plastic fibers, metallic wires and/or aramid fibers.

Typical resin types used in Kevlar ballistic armor are BPA-epoxy compounds with amine harderners. Neat resin properties include a Tg average range of 1-285° C., a tensile strength average range of 1-2900 MPa and a flexural strength average range of 76-1890 MPa. In an embodiment, the Tg is 120-130° C., the tensile strength is 85 MPa, and the flexural strength is 112 MPa.

Particulate reinforcement materials may also be included. Non-limiting examples are graphite, ceramics (including high temperature ceramics such as SiC/boron), nanosilicas, boron nitride, nanoclays, carbon soot, fly ash, coke, carbon, graphite, glassy carbon, amorphous carbon, pitch, non-graphitic powder, carbon black and mixtures thereof.

The reinforcement material may include particles and may be present in an amount of at least 0.50% by weight of the curable composition prior to cure. For example, the actinically curable compositions may include at least 0.6%, 0.7%, 0.8%, 0.9%, 1%, 1.5%, 2%, 3%, 4%, 5%, 6%,7%, 8%, 9%, 10%, 20%, 30%, 40%, 50%, 60%, 70%, 80% or at least 90% by weight of particulate filler. Up to 1% by weight of particulate filler, if present is preferred.

The reinforcement material may include fibers and may be present in an amount of at least 0.50% by weight of the curable composition prior to cure. For example, the actinically curable compositions may include at least 1%, 2%, 3%, 4%, 5%, 6%,7%, 8%, 9%, 10%, 20%, 30%, 40%, 50%, 60%, 70%, 80% or at least 90% by weight of fibers.

The reinforcement material may include continuous fibers and may be present in an amount of at least 0.50% by weight of the curable composition prior to cure. For example, the actinically curable compositions may include at least 1%, 2%, 3%, 4%, 5%, 6%,7%, 8%, 9%, 10%, 20%, 30%, 40%, 50%, 60%, 70%, 80% or at least 90% by weight of continuous fibers.

The reinforcement material may include continuous carbon fibers and may be present in an amount of at least 0.50% by weight of the curable composition prior to cure. For example, the actinically curable compositions may include at least 1%, 2%, 3%, 4%, 5%, 6%,7%, 8%, 9%, 10%, 20%, 30%, 40%, 50%, 60%, 70%, 80% or at least 90% by weight of continuous carbon fibers.

### Other Additives

The curable compositions may contain additives that include, but are not limited to, antioxidants, ultraviolet absorbers, light stabilizers, foam inhibitors, flow or leveling agents, colorants, pigments, dispersants (wetting agents), slip additives, impact modifiers, matting agents, thermoplastics, waxes, or various other additives that do not contain any free-radically polymerizable functional groups, including coatings, sealants, adhesives and additives commonly used in molding or ink applications.

Suitable impact modifiers include ethylene/propylene copolymers, optionally containing a third copolymerizable diene monomer, such as 1,4-hexadiene, dicyclopentadiene, dicyclooctadiene, methylene norbornene, ethylidene norbornene and tetrahydroindene. Other suitable impact modifiers are polybutadiene, polyisoprene, styrene/butadiene random copolymer, styrene/isoprene random copolymer, acrylic rubbers (e.g. polybutylacrylate), ethylene/acrylate random copolymers and acrylic block copolymers, styrene/butadiene/(meth)acrylate (SBM) block-copolymers, styrene/butadiene block copolymer (styrene-butadiene-styrene block copolymer (SBS), styrene-isoprene-styrene block copolymer (SIS) and their hydrogenated versions, SEBS, SEPS), and (SIS) and ionomers. Commercial examples of elastomers are Kraton (SBS, SEBS, SIS, SEBS and SEPS) block copolymers produced by Shell, LOTRYL® ethyl/acrylate random copolymer (Arkema) and Surlyn ionomers (Dupont). Optionally, the elastomer may be modified to contain reactive groups such as e.g., epoxy, oxetane, carboxyl or alcohol. This modification can be introduced by reactive grafting or by copolymerization. Commercial examples of the latter are the LOTADER® random ethylene/acrylate copolymers AX8840 (glycidyl methacrylate/GMA modified), AX8900 and AX8930 (GMA and maleic anhydride modified/MA) produced by Arkema.

In an embodiment, the curable compositions contain a peroxide and/or an azo thermal initiator that decomposes when heated and are thus also curable chemically (i.e., in addition to exposing the curable composition to radiation). Suitable peroxides may include any compound, in particular any organic compound, that contains at least one peroxy (—O—O—) moiety, such as, for example, dialkyl, diaryl and aryl/alkyl peroxides, hydroperoxides, percarbonates, peresters, peracids, acyl peroxides and the like. The at least one accelerator may comprise, for example, at least one tertiary amine and/or one or more other reducing agents based on metal-containing salts (such as, for example, carboxylate salts of transition metal-containing salts such as iron, cobalt, manganese, vanadium and the like and combinations thereof). The accelerator(s) may be selected so as to promote the decomposition of the free radical initiator at room or ambient temperature to generate active free radical species, such that curing of the curable composition is achieved without having to heat or bake the curable composition. In other embodiments, no accelerator is present and the curable composition is heated to a temperature effective to cause decomposition of the free radical initiator and to generate free radical species which initiate curing of the polymerizable compound(s) present in the curable composition. Without wishing to be bound by theory, according to some embodiments, the exotherm provided by the photo-induced polymerization provides enough heat to decompose such chemical (thermal) free radical initiators.

The concentration of thermal initiator in the actinically curable compositions described herein may be varied as desired depending upon the particular compound(s) selected, the type or types of polymerizable compound(s) present in the actinically curable composition, the curing conditions utilized, and the rate of curing desired, among other possible factors. Typically, however, the actinically-curable composition may further include from 0.05% to 5% of a thermal initiator, preferably 0.1% to 2% by weight, based on the total weight of the curable composition, excluding reinforcement material. According to some embodiments, typical concentrations of the thermal initiator may be up to about 15% by weight based on the total weight of the curable composition, excluding the reinforcement material. For example, the actinic radiation-curable composition may comprise from 0.1 to 10% by weight, in total, of thermal initiator, based on the total weight of the curable composition, excluding the reinforcement material.

In a particular embodiment, the peroxide is benzoyl peroxide and the azo thermal initiator is 2,2′-azobis (isobutyronitrile) (AIBN).

The curable compositions may optionally comprise one or more thickening agents (also known as viscosity control agents, thickeners or thickening conferring agents), which serve to modulate the viscosity of the composition and may act as plasticizers and improve material properties such as by increasing strength or impact resistance. A suitable thickening agent for the composition can be selected from those that are compatible with the monomers with which it is combined. Thickening agents are well known in the art and may be, for example, poly(meth)acrylates, acylated cellulose polymers (e.g., cellulose acetate, cellulose acetate propionate), polyvinyl acetates, partially hydrolysed polyvinyl acetates, polyvinylpyrrolidones, polyoxylates, polycaprolactones, polycyanoacrylates, vinyl acetate copolymers (e.g., copolymers with vinyl chloride), copolymers of (meth)acrylates with butadiene and styrene, copolymers of vinyl chloride and acrylonitrile, copolymers of ethylene and vinyl acetate, poly[butyleneterephthalate-co-polyethyleneglycolterephthalate], and copolymers of lactic acid and caprolactone. Such polymeric thickening agents may be distinguished from reinforcement materials by the fact that they are generally soluble in the light-curable resin component of the light-curable composition as well as in the polymeric matrix formed when the light-curable resin component is cured. However, it is recognized that certain of the substances taught herein as reinforcement materials may also function to some extent as thickening agents, while remaining insoluble in the light-curable resin component.

According to certain embodiments, the curable compositions comprise an amount of thickening agent of up to 15% by weight, up to 12% by weight, or up to 10% by weight, based on the weight of the curable composition exclusive of the weight of the reinforcement material component. For example, the curable composition may comprise at least 0.1% by weight, at least 0.5% by weight or at least 1% by weight of thickening agent, based on the weight of the curable composition exclusive of the weight of the reinforcement material component. The curable composition may include a thixotropic agent to regulate the flow behavior thereof, where the thixotropic agent may be organic or inorganic and selected in certain embodiments from the group consisting of hydrogenated castor oil, hydrogenated castor oil modified by reaction with an amine, polyamides, and silica (e.g., hydrophobic fumed or precipitated silica). However, if a thixotropic agent is present, its concentration is typically limited to no more than 5% by weight based on the total weight of the curable composition.

### Additive Manufacturing Methods

The curable compositions may be prepared by any suitable method, including simply mixing together the various desired ingredients in the desired proportions. According to certain embodiments of the invention, the curable resin components of the curable composition are prepared and stored separately from the reinforcement material component, with the two components then being combined to form the light-curable composition shortly before or simultaneously with curing of the curable composition. The curable resin components and the curable composition are preferably stored in packaging which is shielded from light having a wavelength effective to initiate curing of the curable resin component or of the curable composition. For example, the package or container may be light shielded from wavelengths between 300 nm and 750 nm. The interior surface of the package or container should also be selected to be compatible with maintaining the curable composition in an uncured, stable form over an extended period of storage time. For example, the interior package or container surface may be constructed of a low energy surface plastic or passivated glass or metal.

The curable compositions are useful for preparing composite materials by photocuring the curable resin component to form a polymeric matrix. The cured polymeric matrix encompasses and binds together the reinforcement material component of the curable composition. The reinforcement material component serves to improve the mechanical properties, as compared to the chemical properties of a cured polymeric matrix obtained by curing the light-curable resin component in the absence of the filler component. For example, where the reinforcement material is in the form of fibers, a fiber-reinforced composite material may be obtained by photocuring a curable composition in accordance with the present invention.

In general, a composite material may be defined as any material containing a reinforcement material which is supported by a binder material. Composite materials thus may comprise a two-phase material having a discontinuous reinforcement material phase that is stiffer and/or stronger than the continuous binder (matrix) phase. In the context of composite materials prepared in accordance with the present invention, the reinforcement material may function as a rigidifying agent while the polymeric matrix formed by photocuring the light-curable resin component of the light-curable composition may function as a binder material.

Curable compositions in accordance with the present invention can be used as coatings, adhesives, sealants, potting compounds, encapsulants, and other such products, but are of particular interest for curing in the bulk and in the production of bulk objects or monoliths by photocuring.

A method for curing the light-curable compositions of the present invention using light irradiation may comprise irradiating the curable composition with electron beam, ultraviolet light, visible light or near infrared light using any suitable radiation source such as a long wave UV lamp, a low intensity arc lamp, a high intensity arc lamp, a high pressure mercury lamp, a halogen lamp, a light emitting diode (LED), a xenon lamp, or sunlight.

Ultraviolet (UV) and visible light are generally preferred. The effective wavelength(s) of the irradiated light will vary depending upon the particular photoinitiator system employed and/or photocleavable compounds present in the photoinitiator system.

Thus, the light source employed should provide light in the wavelength range dictated by the particular photoinitiator system used. Ideally the wavelength of the light emitted from the light source (such as an LED) should couple strongly with the absorption of the photoinitiator system of the light-curable resin composition. While unnecessary, light in wavelengths outside the desired photopolymerization range for the particular photoinitiator system could be filtered out. Still further, the light source employed can emit light to penetrate throughout one or more faces or sides of the composite part being fabricated.

According to certain embodiments of the invention, the curable composition may be formulated to be capable of being cured upon exposure to light having a wavelength of 350 nm to 490 nm, or 365 nm to 465 nm, or 380 nm to 410 nm. The light intensity may be, for example, from 20 mW/cm² to 150 mW/cm², or 40 mW/cm² to 90 mW/cm². The curable composition may be stationary when exposed to light. Alternatively, the curable composition may be in motion when exposed to light (for example, on a conveyor belt). A portion of light-curable composition to be photocured in accordance with the present invention to form a composite material or article may be irradiated with light from a single direction or from multiple directions. However, a distinct advantage of the present invention is that light irradiation from just a single direction can be effective to cause complete curing of the curable composition throughout the composite material or article, despite the presence of a reinforcement material capable of blocking penetration of the incident light or reinforcement material capable of scattering the incident light in an manner such that light does not reach all regions of light-curable resin component within the composition.

A variety of procedures for forming a composite article using the light-curable compositions of the present invention may be used. For instance, a mold for the desired composite article may be employed which has at least one face or side transparent to the initiating light so that the light can penetrate adequately to allow the photocuring to take place, a suitable light source, and the desired light-curable composition itself in an amount adequate to fill the mold. The particular sequence of the procedure actually used can vary as desired. For example, the mold can be filled either before or after the light source being used is turned on. The light-curable composition may be introduced in combined form into the mold. For instance, the reinforcement material(s) may be dispersed in the remaining components of the curable composition and the mold then filled with the resulting mixture. However, the reinforcement material(s) may be introduced into the mold separately from the other components of the curable composition. For example, the reinforcement material as introduced into the mold may be a preform, such as a fiber mat (woven or nonwoven). According to one embodiment, the reinforcement material component when introduced into the mold may be pre-wetted or pre-impregnated with a quantity of a liquid admixture of the other components of the curable composition, with an additional quantity of such admixture subsequently introduced into the mold wherein the additional quantity of the admixture combines with the pre-wetted reinforcement material component. It is also possible to form structured or layered composite articles, which may be characterized by having one or more regions or layers containing little or no filler and one or more regions or layers containing a relatively high concentration of reinforcement material.

A distinct advantage of the present invention is that it makes possible the efficient production of composite articles that are relatively thick, despite the presence of substantial amounts of reinforcement material that block or scatter light. For example, the thickness of the composite article produced in certain embodiments may in the range of about 0.1 centimeter up to about 10 centimeters or even more. The present invention is highly useful for forming composite articles in this thickness range, but the present invention is likewise amenable to forming composite articles that are much thicker than the 0.1-10 centimeter range.

However, the light-curable compositions of the present invention are also suitable for forming relatively thin composite films or coatings. Such cured composite films and coatings may, for example, have a thickness of at least 10 microns, at least 50 microns or at least 100 microns, up to 0.5 mm or 1 mm. It is also possible, within the scope of the present invention, to build up an article layer-by-layer using the light-curable compositions, wherein a first thin layer of the light-curable composition having, for example, a thickness of 10 microns to 500 microns is formed and exposed to light, with a second thin layer of the light-curable composition then being deposited on the first thin layer and exposed to light, followed by one or more successive thin layers of the light-curable composition wherein such successive thin layers are also exposed to light before depositing the next thin layer.

It should be appreciated that the present invention may be utilized to form any article, shape or part for any application. All that is intended by an “article” is a three-dimensional shape configured for the intended application. Using the present invention, it is also possible to produce composite articles in which one or more portions of the composite article comprise a composite material obtained by curing of a curable composition in accordance with the invention and one or more portions of a material (e.g., metal, ceramic, plastic) that is not derived from the curable composition. For example, the composite article may comprise a substrate of a first material (not derived from a curable composition in accordance with the invention) having at least one surface which is in contact with (e.g., adhered to or bonded to) a composite material in accordance with the present invention. The curable compositions of the present invention may also be utilized to fabricate useful articles by methods such as additive manufacturing (including three dimensional (3D) printing) and pultrusion. Such methods may be moldless and/or out-of-autoclave (OOA) methods. Suitable 3D printing systems include stereolithography (SLA), digital light processing (DLP), hot lithography, and continuous liquid interface production (CLIP). As an example, a dispensing head equipped with a light source may be used to impregnate a fiber strand or tow with a light-curable resin component (comprised of the components of a light-curable composition in accordance with the invention, with the exception of the fiber) to form a curable composition within the dispensing head and then cure the curable composition using light immediately after material deposition to provide a cured composite material. In this manner, a three-dimensional composite article containing oriented reinforcement fibers may be prepared, without molds or other support materials.

Well recognized ASTM standards associated with 3D printing include the following:

| | |
|---|---|
| Tensile Strength | ASTM D638M |
| Elongation at Break | ASTM D638M |
| Elongation at Yield | ASTM D638M |
| Modulus of Elasticity | ASTM D638M |
| Flexural Strength | ASTM D790M |
| Flexural Modulus | ASTM D790M |
| Izod Impact-Notched | ASTM D256A |
| Hardness (Shore D) | ASTM D2204 |
| Glass Transition Temperature | ASTM E1545-00 |
| HDT @ 0.46 MPa | ASTM D648-98c |
| HDT @ 1.81 MPa | ASTM D648-98c |

Light-curable compositions in accordance with the present invention are also suitable for use in Automated Fiber Placement (AFP) and Automated Tape Lay-Up (ATL) processes.

While the light-curable composition is being exposed to light in a manner effective to initiate curing, the curable composition may suitably be at about room temperature (e.g., about 10° C. to about 35° C.). However, it is also possible to maintain the curable composition while being exposed to light at an elevated temperature (e.g., greater than 35° C. to about 100° C.). If desired, a post-photocuring operation can be carried out on the thus-produced composite article. For example, thermal curing, as in a heated oven, may be utilized.

The curable compositions of the present invention can also be used as inks (in graphic art applications, including for food packaging), molding resins, 3D printing resins, coatings (such as fiber coatings) and sealants and adhesives (such as UV-cured laminating adhesives, UV-curable hot melt adhesives).

The cured compositions prepared from the curable compositions described herein may be used, for example, as a three-dimensional object (where the three-dimensional object may consist essentially of the cured composition), coated articles (i.e., one of the substrates is coated with one or more layers of the cured composition), laminated or adhered articles (i.e., one of the first components is layered by the cured composition) bonded or adhered to a second component, or a printed article (in which the cured composition is used to print graphics or the like onto a substrate such as a paper, plastic or metal substrate).

Prior to curing, the curable composition can be applied to a substrate by any known conventional means, for example, by spray coating, knife coating, roll coating, casting, drum coating, dip coating, and the like, and combinations thereof. Indirect coating using a transfer method can also be used. The substrate can be any commercially relevant substrate, such as a high surface energy substrate or a low surface energy substrate, such as a metal substrate or a plastic substrate, respectively. The substrate may include metals, paper, cardboard, glass, thermoplastics such as polyolefins, polycarbonates, acrylonitrile butadiene styrene (ABS), and blends thereof, composites, wood, leather, and combinations thereof. When used as an adhesive, the curable compositions may be placed between two substrates and subsequently cured, whereby the cured composition bonds the substrates together.

A plurality of layers of the composition according to the present invention can be applied to the substrate surface, where the plurality of layers may be cured simultaneously (by exposure to a single dose of radiation, for example) or the layers may be cured continuously before coating another layer of the composition.

The curable composition described in this case is particularly useful as a 3D printing resin formulation, that is, a composition intended to manufacture a three-dimensional object using 3D printing technology. Such three-dimensional objects may be free standing/self-supporting and may consist essentially of a cured curable composition. The three-dimensional object may also be a composite material, including at least one component consisting essentially of the previously mentioned cured composition or consisting of the previously mentioned cured composition, and containing at least one additional component (for example, a metal component or a thermoplastic component) of one or more materials.

A method for making a three-dimensional object using the curable composition according to the present invention may include the following steps: a) applying a first layer of the curable composition according to the present invention to a surface; b) curing the first layer to provide a cured first layer; c) applying a curable composition of a second layer to the cured first layer; d) curing the second layer to provide adhesion to the cured layer of one of the first layers of the cured second layer; and e) repeating steps c) and d) as many times as necessary to construct the three-dimensional object.

In some specific examples of the present invention, curing of the curable composition is accomplished by exposing the curable composition to an effective amount of radiation (such as electron beam radiation, UV radiation, visible light, etc.).

Accordingly, in various embodiments, the present invention provides a method including the following steps: a) applying a first layer of the curable composition according to the present invention in a liquid form onto a surface; b) exposing the first layer to actinic radiation to form a first exposure imaging cross-section, where the radiation is of sufficient intensity and duration to cause at least partial curing of the layer within the exposed area (e.g., at least 80% or at least 90% cured); c) applying an additional layer of the curable composition to a previously exposed imaging cross-section; d) exposing the additional layer to actinic radiation in an imaging manner to form an additional imaging cross section in which the radiation is of sufficient strength and duration to cause the additional layer in the exposed area to be at least partially cured (e.g., at least 80% or at least 90% cured) and to attach the additional layer to a previously exposed image cross section; and e) repeating steps c) and d) as many times as necessary to construct the three-dimensional object.

Methods for employing the curable compositions in preparing three dimensionally printed articles using conventional 3D printing technologies are not particularly limited and include digital light projection, stereolithography and multi jet and binder jet printing.

In an embodiment of the curable composition comprising continuous fibers as the reinforcement material, continuous fiber 3D printing (a.k.a., CF3D®) is the preferred method. CF3D® involves the use of continuous fibers embedded within material discharging from a moveable print head. A matrix is supplied to the print head and discharged (e.g., extruded and/or pultruded) along with one or more continuous fibers also passing through the same head at the same time. The matrix can be a traditional thermoplastic, a liquid thermoset (e.g., a UV curable and/or two-part resin), or a combination of any of these and other known matrixes. Upon exiting the print head, a cure enhancer (e.g., a UV light, a laser, an ultrasonic emitter, a heat source, a catalyst supply, etc.) is activated to initiate, enhance, and/or complete curing of the matrix. This curing occurs almost immediately, allowing for unsupported structures to be fabricated in free space. When fibers, particularly continuous fibers, are embedded within the structure, a strength of the structure may be multiplied beyond the matrix-dependent strength. An example of this technology is disclosed in U.S. Pat. No. 9,511,543.

In a curing embodiment, a method for curing the curable composition comprises subjecting the curable composition to actinic radiation sufficient to cure the curable composition.

In an embodiment, a method of making a three dimensionally printed composite article comprises:
discharging the actinically curable composition from a print head, the actinically curable composition including reinforcement material;
moving the print head during discharging the actinically curable composition; and
irradiating the actinically curable composition to form a cured three dimensionally printed composite article.

In another embodiment, a method of making a three dimensionally printed carbon bonded composite article using continuous fiber 3D (CF3D®), comprises:
irradiating the actinically curable composition in the presence of continuous carbon fibers to form a cured three dimensionally printed carbon bonded composite article.

In various embodiments, the curable composition is applied as a single deposition.

In various embodiments, the cured composite article has low optical transparency.

In an embodiment, the print head contains the curable composition.

Certain non-limiting aspects of the invention are summarized below:

Aspect 1. An actinically curable composition comprising:
(a) 20 to 80 wt % of an acrylamide or methacrylamide satisfying the criteria of (1) having an average dipole moment of 2.5 or greater; (2) hydrogen or a methyl group or a methylene group at the alpha position to the nitrogen atom of the acrylamide or methacrylamide, and hydrogen, a methyl group, a methylene group, a methine group, a heteroatom or an aromatic group at the beta position to the nitrogen atom; and (3) two or more heteroatoms per molecule of the acrylamide or methacrylamide;
(b) 10 to 60 wt % of at least one monomer of formula (II);

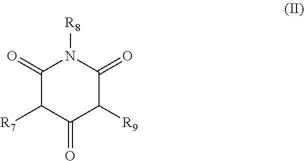

(c) 0-30 wt % of a urethane (meth)acrylate oligomer; and
(d) 0.1-5 wt % of a photoinitiator,
   wherein:

R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂.

R₁₀ is selected from the group consisting of H and C₁-C₃ alkyl; and

n is 1, 2, 3 or 4.

Aspect 2. An actinically curable composition comprising:
(a) 20 to 80 wt % of at least one monomer of formula (I);

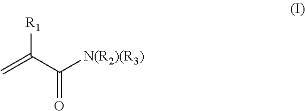

(b) 10 to 60 wt % of at least one monomer of formula (II);

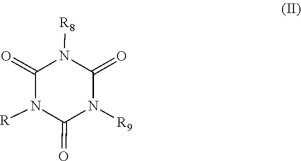

(c) 0-30 wt % of a urethane (meth)acrylate oligomer; and
(d) 0.1-5 wt % of a photoinitiator,
   wherein:

R₁ is H or C₁-C₃ alkyl;

R₂ and R₃ are each independently selected from the group consisting of H, C₁-C₃ alkyl, CH₂—CH(OH)C₁-C₃ alkyl and (CH₂)ₘX,

or R₂ and R₃ together with the nitrogen atom to which they are attached form a 3- to 6-membered saturated heterocyclic ring;

X is OR₄, SR₄, NR₅R₆, OP(═O)(OR₄)₂, CH₂P(═O)(OR₄)₂ or an aromatic group;

R₄ is selected from the group consisting of H and C₁-C₄ alkyl;

R₅ and R₆ are each independently selected from the group consisting of H and C₁-C₃ alkyl;

m is 1, 2, 3, 4 or 5;

R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂.

R₁₀ is selected from the group consisting of H and C₁-C₃ alkyl; and

n is 1, 2, 3 or 4.

Aspect 3. The curable composition of Aspect 2, wherein R₁ is H, and R₂ and R₃ together with the nitrogen atom to which they are attached form a 5- or 6-membered saturated heterocyclic ring for the monomer of formula (I).

Aspect 4. The curable composition of any of Aspects 1-3, wherein at least one of R₇, R₈ and R₉ is (CH₂)ₙO(C═O)—CR₁₀═CH₂ where n is 2 for the monomer of formula (II).

Aspect 5. The curable composition of any of Aspects 1-3, wherein at least two of R₇, R₈ and R₉ is (CH₂)ₙO(C═O)—CR₁₀═CH₂ where n is 2 for the monomer of formula (II).

Aspect 6. The curable composition of any of Aspects 1-3, wherein at least one of R₇, R₈ and R₉ is (CH₂)ₙO(C═O)—CR₁₀═CH₂ where n is 2 and R₁₀ is H for the monomer of formula (II).

Aspect 7. The curable composition of any of Aspects 1-3, wherein at least two of R₇, R₈ and R₉ is (CH₂)ₙO(C═O)—CR₁₀═CH₂ where n is 2 and R₁₀ is H for the monomer of formula (II).

Aspect 8. The curable composition of any of Aspects 2-7, wherein the acrylamide/methacrylamide or monomer of formula (I) is selected from the group consisting of:

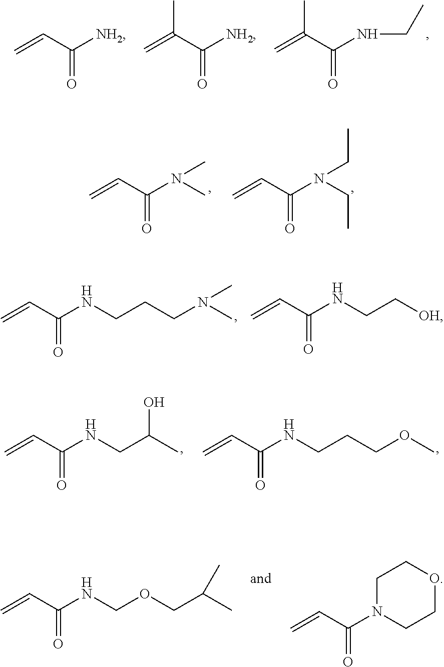

Aspect 9. The curable composition of any of Aspects 2-8, wherein the monomer of formula (I) is acryloyl morpholine (ACMO):

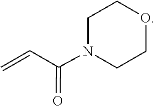

Aspect 10. The curable composition of any of Aspects 2-9, wherein the monomer of formula (II) is tris(2-hydroxyethyl)isocyanurate triacrylate (M370):

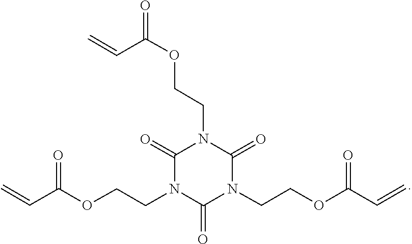 [SMILES: C=CC(=O)OCCn1c(=O)n(CCOC(=O)C=C)c(=O)n(CCOC(=O)C=C)c1=O]

Aspect 11. The curable composition of any of Aspects 2-10, wherein the monomer of formula (I) is ACMO:

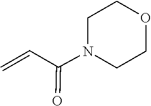

and the monomer of formula (II) is M370:

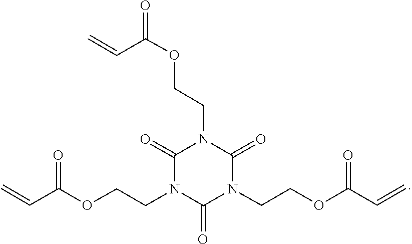 [SMILES: C=CC(=O)OCCn1c(=O)n(CCOC(=O)C=C)c(=O)n(CCOC(=O)C=C)c1=O]

Aspect 12. The curable composition of any of Aspects 1-11, wherein the curable composition further comprises a reinforcement material (filler).

Aspect 13. The curable composition of any of Aspects 1-12, wherein the reinforcement material is an opaque reinforcement material (opaque filler) or a light scattering reinforcement material.

Aspect 14. The curable composition of any of Aspects 1-13, wherein the opaque filler or light scattering filler comprises continuous fibers.

Aspect 15. The curable composition of any of Aspects 1-14, wherein the opaque filler comprises continuous carbon fibers.

Aspect 16. The curable composition of any of Aspects 1-15, wherein the reinforcement material is selected from the group consisting of glass, fiberglass, chopped carbon fibers, continuous carbon fibers and Kevlar, optionally in the presence of one or more of nylon, polylactic acid (PLA), acrylonitrile butadiene styrene (ABS), polyethylene terephthalate glycol (PETG) and polycarbonate.

Aspect 17. The curable composition of any of Aspects 1-16, wherein the reinforcement material is not glass.

Aspect 18. The curable composition of any of Aspects 1-17, wherein the reinforcement material is fiberglass or continuous carbon fibers.

Aspect 19. The curable composition of any of Aspects 1-18, wherein the urethane (meth)acrylate oligomer is selected from the group consisting of PHOTOMER® 6008, PHOTOMER® 6010, PHOTOMER® 6019, PHOTOMER® 6184, PHOTOMER® 6630 and PHOTOMER® 6892.

Aspect 20. The curable composition of any of Aspects 1-19, wherein the photoinitiator is selected from the group consisting of benzophenones, benzoin ethers, benzyl ketals, α-hydroxyalkylphenones, α-alkoxyalkylphenones, α-aminoalkylphenones and acylphosphines.

Aspect 21. The curable composition of any of Aspects 1-20, wherein the photoinitiator is selected from the group consisting of 1-hydroxy-cyclohexyl-phenyl-ketone (IRGACURE® IC-184); 2,4,6-trimethylbenzoyldiphenylphosphine oxide (LUCIRIN® TPO); 2,4,6-trimethylbenzoylethoxyphenylphosphine oxide (LUCIRIN® TPO-L); bis(2,4,6-trimethylbenzoyl)-phenyl-phosphine oxide (IRGACURE® 819); 2-methyl-1-(4-methylthio)phenyl-2-(4-morpholinyl)-1-propanone (IRGACURE® 907) and 1-(4-(2-hydroxyethoxy)phenyl)-2-hydroxy-2-methylpropan-1-one (IRGACURE® 2959); 2-benzyl 2-dimethylamino 1-(4-morpholinophenyl)-butanone-1 (IRGACURE® 369); 2-hydroxy-1-(4-(4-(2-hydroxy-2-methylpropionyl)-benzyl)-phenyl)-2-methylpropan-1-one (IRGACURE® 127); and 2-dimethylamino-2-(4-methylbenzyl)-1-(4-morpholin-4-yl-phenyl)-butan-1-one (IRGACURE® 379).

Aspect 22. The curable composition of any of Aspects 1-22, wherein the curable composition further comprises an acrylate or methacrylate satisfying the criteria of (1) having an average dipole moment of 2.5 or greater; (2) methyl or methylene at the alpha position to the oxygen atom of the acrylate or methacrylate and hydrogen, methyl, methylene, methine, heteroatom or aromatic at the beta position to the oxygen atom; and (3) three or more heteroatoms per acrylate molecule and four or more heteroatoms per methacrylate molecule.

Aspect 23. The curable composition of any of Aspects 2-22, wherein the curable composition further comprises further comprises a monomer of formula (III)

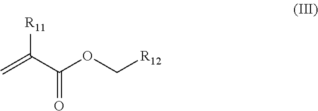

wherein:

each Ru is independently H or C₁-C₃ alkyl; and

R₁₂ is selected from the group consisting of:
a heterocycle containing at least one of N, O or S when Ru is H and at least two of N, O or S when Ru is CH₃;
a C₂-C₆ alkylene chain wherein at least one carbon atom of the alkylene chain is replaced by N, O or S when Ru is H, the alkylene chain terminating in a C₁-C₃ alkyl group;
a C₂-C₆ alkylene chain wherein at least two carbon atoms of the alkylene chain are replaced by N, O or S when R₁₁ is CH₃; the alkylene chain terminating in a C₁-C₃ alkyl group; and
a C₂-C₆ alkylene chain wherein one or more carbon atoms of the alkylene chain are optionally replaced by N, O or S, the alkylene chain terminating in a acrylate group (—O—C(═O)—CH═CH₂) or a methacrylate group (—O—C(═O)—C(CH₃)═CH₂).

Aspect 24. The curable composition of any of Aspects 2-23, wherein for the monomer of formula (III), R₁₁ is H and R₁₂ is selected from the group consisting of:

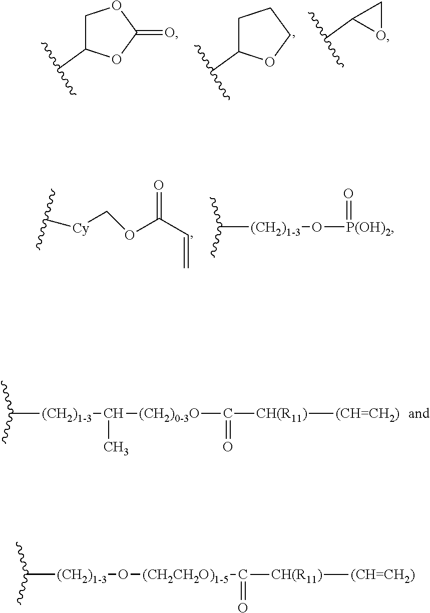

where Cy is a cycloalkyl group having 3 to 7 ring carbons.

Aspect 25. The curable composition of any of Aspects 2-24, wherein for the monomer of formula (III), R₁₁ is CH₃ and R₁₂ is selected from the group consisting of:

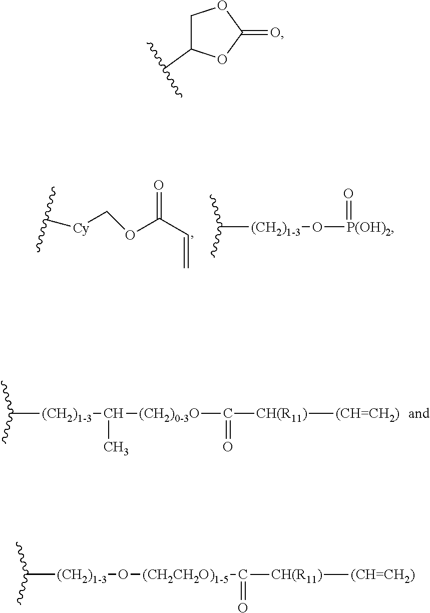

where Cy is a cycloalkyl group having 3 to 7 ring carbons.

Aspect 26. The curable composition of any of Aspects 1-25, wherein the curable resin further comprises a peroxide.

Aspect 27. The curable composition of any of Aspects 1-26, wherein the curable resin further comprises an azo thermal initiator.

Aspect 28. A method for curing the curable composition of any of Aspects 1-27 comprising subjecting the curable composition to actinic radiation sufficient to cure the curable composition.

Aspect 29. A method for making a three dimensionally printed composite article comprising:
discharging the actinically curable composition of any of Aspects 1-27 from a print head, the actinically curable composition including reinforcement material;
moving the print head during discharging the actinically curable composition; and
irradiating the actinically curable composition to form a cured three dimensionally printed composite article.

Aspect 30. A method for making a three dimensionally printed carbon bonded composite article using continuous fiber 3D (CF3D®), comprising:
irradiating the actinically curable composition of any of Aspects 1-27 in the presence of continuous carbon fibers to form a cured three dimensionally printed carbon bonded composite article.

Aspect 31. The method of any of Aspects 28-30, wherein the curable composition is applied as a single deposition.

Aspect 32. The method of any of Aspects 28-30, wherein the cured composite article has low optical transparency.

Aspect 33. The method of any of Aspects 28-30, wherein the print head contains the curable composition.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the actinic radiation-curable compositions, methods for making the actinic radiation-curable compositions, methods for using the actinic radiation-curable compositions, and articles prepared from the actinic radiation-curable compositions. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1. Manufacturing Process

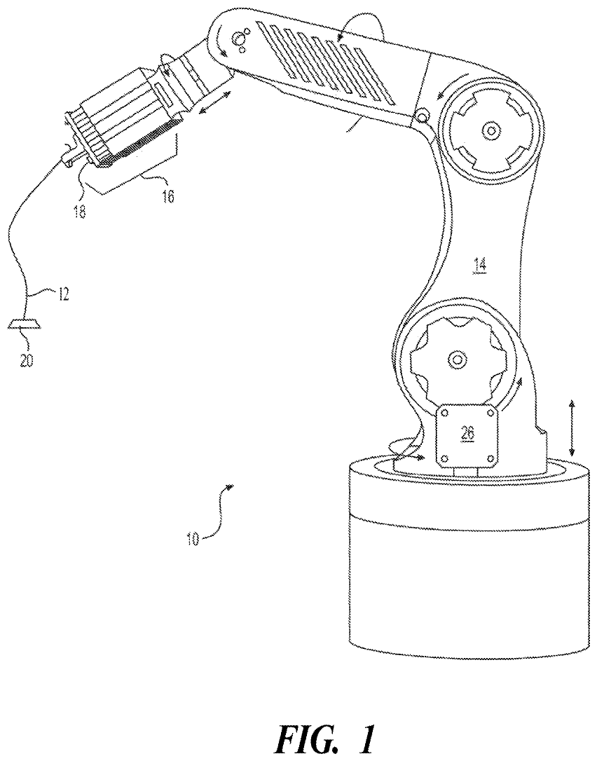

FIG. 1 illustrates an exemplary system 10, which may be used to manufacture a composite structure 12 having any desired shape, size, configuration, and/or material composition. System 10 may include at least a support 14 and a head 16. Head 16 may be coupled to and moveable by support 14 during discharge of a composite material (shown as C). In the disclosed embodiment of FIG. 1, support 14 is a robotic arm capable of moving head 16 in multiple directions during fabrication of structure 12, such that a resulting longitudinal axis (e.g., a trajectory) of the discharge is three-dimensional. Support 14 may alternatively embody a gantry (e.g., an overhead-bridge gantry, a single-post gantry, etc.) or a hybrid gantry/arm also capable of moving head 16 in multiple directions during fabrication of structure 12. Although support 14 is shown as being capable of 6-axis movements, it is contemplated that any other type of support 14 capable of moving head 16 in the same or a different manner could also be utilized. In some embodiments, a drive or coupler may mechanically join head 16 to support 14, and include components that cooperate to move portions of and/or supply power and/or materials to head 16.

Head 16 may be configured to receive or otherwise contain a matrix that, together with a continuous reinforcement, makes up the composite material discharging from head 16. The matrix may include any type of material that is curable (e.g., a liquid resin, such as a zero-volatile organic compound resin, a powdered metal, etc.). Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16 and pushed or pulled out of head 16 along with one or more continuous reinforcements. In some instances, the matrix inside head 16 may benefit from being kept cool and/or dark (e.g., in order to inhibit premature curing or otherwise obtain a desired rate of curing after discharge). In other instances, the matrix may need to be kept warm for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, socks, and/or sheets of continuous material) and, together with the reinforcements, make up a portion (e.g., a wall) of composite structure 12. The reinforcements may be stored within (e.g., on one or more separate internal creels—not shown) or otherwise passed through head 16 (e.g., fed from one or more external spools—not shown). When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, metallic wires, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers) may be mixed with the matrix before and/or after the matrix coats the continuous reinforcements.

As will be explained in more detail below, one or more cure enhancers (e.g., a UV light, an ultrasonic emitter, a laser, a heater, a catalyst dispenser, etc.) 18 may be mounted proximate (e.g., within, on, or adjacent) head 16 and configured to enhance a cure rate and/or quality of the matrix as it is discharged from head 16. The cure enhancer(s) 18 may be controlled to selectively expose portions of structure 12 to energy (e.g., to UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, or otherwise cause the matrix to cure as it discharges from head 16. The amount of energy produced by the cure enhancer(s) 18 may be sufficient to cure the matrix before structure 12 axially grows more than a predetermined length away from head 16. In one embodiment, structure 12 is cured before the axial growth length becomes equal to an external diameter of the matrix-coated reinforcement.

The matrix and/or reinforcement may be discharged from head 16 via at least two different modes of operation. In a first mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is being pulled from head 16 with the reinforcement, the resulting tension in the reinforcement may increase a strength of structure 12 (e.g., by aligning the reinforcements, inhibiting buckling, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor point (e.g., a print bed, a table, a floor, a wall, a surface of structure 12, etc.—not shown) 20. In particular, at the start of structure formation, a length of matrix-impregnated reinforcement may be pulled and/or pushed from head 16, deposited onto the anchor point 20, and at least partially cured, such that the discharged material adheres (or is otherwise coupled) to the anchor point 20. Thereafter, head 16 may be moved away from the anchor point 20, and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor point 20, such that tension is created within the reinforcement. It is contemplated that the anchor point 20 could be moved away from head 16 instead of or in addition to head 16 being moved away from the anchor point 20.

A controller 26 may be provided and communicatively coupled with support 14, head 16, and any number of the cure enhancer(s) 18. Each controller 26 may embody a single processor or multiple processors that are specially programmed or otherwise configured to control an operation of system 10. Controller 26 may include one or more general or special purpose processors or microprocessors. Controller 26 may further include or be associated with a memory for storing data such as, for example, design limits, performance characteristics, operational instructions, tool paths, and corresponding parameters of each component of system 10. Various other known circuits may be associated with controller 26, including power supply circuitry, signal-conditioning circuitry, solenoid driver circuitry, communication circuitry, and other appropriate circuitry. Moreover, controller 26 may be capable of communicating with other components of system 10 via wired and/or wireless transmission.

One or more maps may be stored in the memory of controller 26 and used by controller 26 during fabrication of structure 12. Each of these maps may include a collection of data in the form of lookup tables, graphs, and/or equations. In the disclosed embodiment, controller 26 may be specially programmed to reference the maps and determine movements of head 16 required to produce the desired size, shape, and/or contour of structure 12, and to responsively coordinate operation of support 14, the cure enhancer(s) 18, and other components of head 16.

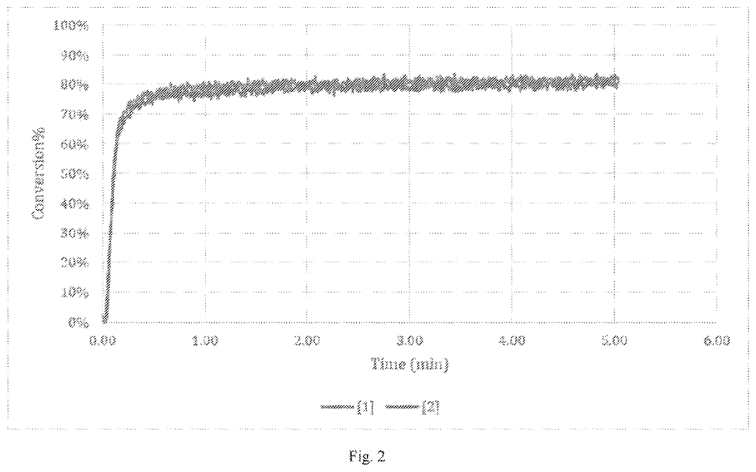

An exemplary matrix that may be used in system 10, particularly with reinforcements that are somewhat opaque (e.g., carbon fibers), is disclosed in FIG. 2 and in tables T-1, T-2, and T-3 below.

T-1. Curable composition

| | wt % | Ranges |
|---|---|---|
| ACMO | 28.8% | 20-80 |
| M370 | 52.9% | 10-60 |
| Photomer 6019 | 14.4% | 0-30 |
| Irgacure 819 | 3.8% | 0.1-5 |

T-2. Identification of components of curable composition

| Name | Material | CAS | Vendor | Chemical Structure |
|---|---|---|---|---|
| ACMO | 4-(1-oxo-2-propenyl)- morpholine | 5117-12-4 | Rahn | 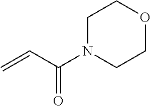 |
| M370 (SR368) | tris(2- hydroxyethyl) isocyanurate triacrylate | 40220-08-4 | Miwon or Sartomer | 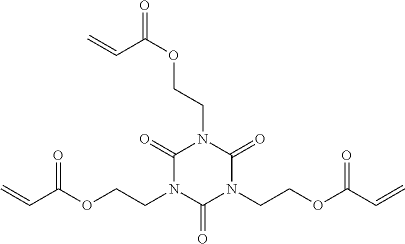 [SMILES: C=CC(=O)OCCn1c(=O)n(CCOC(=O)C=C)c(=O)n(CCOC(=O)C=C)c1=O] |
| PHOTOMER ® | 2-propenoic acid, | Proprietary | IGM | — |
| 6019 | 2-hydroxyethyl ester, | | | |
| | polymer with 5- | | | |
| | isocyanato-1-(iso- | | | |
| | cyanatomethyl)-1,3,3- | | | |
| | trimethylcyclohexane | | | |
| | and α, α′, α″-1,2,3- | | | |
| | propanetriyltris[w- | | | |
| | hydroxy- | | | |
| | poly[oxy(methyl | | | |
| | 1,2-ethanediyl)] | | | |
| IRGACURE ® 619 | Phenyl bis(2,4,6- trimethylbenzoyl)- phosphine oxide | 162881- 26-7 | Rahn | 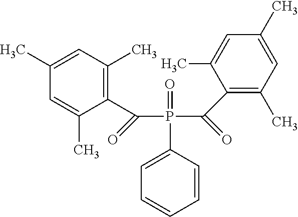 |

T-3. Evaluated Properties

| | |
|---|---|
| Tensile properties | n/a |
| Flexural Properties | Modulus 2300 mPa |
| | Strength 120 mPa |
| | Deflection 9% |
| Water absorption | n/a |
| Tg | n/a |
| Stress relaxation | n/a |
| Viscosity | @25° C. 1.200 |
| (cPs) | @60° C. 180 |

Double bond conversion was followed by FTIR (Fourier Transform Infrared) spectroscopy in bulk of two batches of V1.1. FIG. 2 shows the rates of conversion for the first and second batches. Tests were run under 10 mW/cm² 405 nm LED light for 5 minutes. There appears to be little to no difference in reaction rates. It should be noted that an LED light having 325-425 nm wavelength may alternatively be utilized.

### INDUSTRIAL APPLICABILITY

The disclosed system and matrix may be used to continuously manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail.

At a start of a manufacturing event, information regarding a desired structure 12 may be loaded into system 10 (e.g., into controller 26 that is responsible for regulating operations of support 14 and/or head 16). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement stipulations, compaction requirements, curing requirements, etc. It should be noted that this information may alternatively or additionally be loaded into system 10 at different times and/or continuously during the manufacturing event, if desired.

Based on the component information, one or more different reinforcements and the disclosed matrix may be selectively loaded into head 16. For example, the reinforcement may be loaded onto a creel (e.g., an internal head-mounted creel and/or external offboard creel—both not shown) and head 16 may be supplied with the matrix. The reinforcement(s) may then be threaded through head 16 prior to start of the manufacturing event. The reinforcement may be wetted with the matrix inside of head 16 and discharged in a desired manner (e.g., pulled and/or pushed from head 16).

Head 16 may then be moved by support 14 under the regulation of controller 26 to cause matrix-wetted reinforcements to be placed against or on a corresponding anchor point 20. Cure enhancer(s) 18 may then be selectively activated to expose the matrix to energy, thereby causing hardening of the matrix surrounding the reinforcements and bonding the reinforcements to the anchor point 20. Thereafter, head 16 may be moved in any trajectory to pull wetted-reinforcements from head 16 onto existing surfaces and/or into free space to form structure 12.

In an embodiment, the cured composite article prepared from the curable composition (in the absence of any reinforcement materials) has the following physical properties:
a Tg greater than 130° C.;
a flexural modulus of 1.4 GPa to 2 GPa;
a tensile strength of 6.8 MPa to 9.6; and
a flexural strength of 34 MPa to 69 MPa.

In another embodiment, the Tg is greater than 150° C., the flexural modulus is greater than 1.7 GPa, the tensile strength is greater than 7.3 MPa and the flexural strength is greater than 45 MPa.

### Example 2. Impact of Varying AMOC Concentration

Pinning Test: In the Pinning test, fibers were wetted with resin and then laid down on a granite slab. Excess resin was removed with a squeegee. The fibers were cured under the LED on a conveyer system at specific speeds. A second strand of fibers were wetted and laid down on top of the first cured fiber such that the overlap was consistent and approximately 70 mm. The overlapping fibers were then cured under the LED as before. Initially test were run by yanking them apart to see if they held, or qualitatively how hard they had to be yanked to come apart. More quantitatively in later tests, these overlapping fibers were pulled at a constant speed (150 mm/min) with a known force via a material testing unit.

Curing conditions: Using an LED provided by CC3D, a rig was constructed such that fibers on top of a granite slab could be move under the LED at a controlled speed by a conveyer system. Due to the small spot size the intensity could not be measured. The indicators “Good” and “Very Good” were qualitative measures of how well the cured together strands in the pinning test stayed together. “Good” strands were able to be separated by hand, but took effort. “Very Good” took several pulls to come apart, or did not come apart.

Table 4 identifies the two formulations used in the pinning study in Table 5. Table 6 is a general description of the formulations. Additionally, Table 7 shows ACMO at 40 wt % with good results.

Formulations with 30 wt % and 40 wt % ACMO both performed well.

T-4. Formulation composition

| | | |
|---|---|---|
| # 1 | ACMO | 30% |
| | M370 | 55% |
| | PHOTOMER ® 6019 | 15% |
| | IRGACURE ® 819 | 4% |
| # 2 | ACMO | 30% |
| | M370 | 45% |
| | PHOTOMER ® 6019 | 30% |
| | IRGACURE ® 819 | 4% |

T-5. Pinning force of each formulation
in Table 4 at various temperatures

| Formulation | Temperature | Force/area |
|---|---|---|
| 1 | Ambient | 0.5 |
| | 50 | 0.65 |
| | 100 | 0.4 |
| 2 | Ambient | 1.1 |
| | 50 | 0.3 |
| | 100 | 0.2 |

T-6. Formulation explanation

| Formulation | Description |
|---|---|
| 1 | Acrylate/Amide/15% high |
| 2 | Acrylate/Amide/30% high |

T-7. Flexural properties and pinning results of select formulations

| | | | | | | Carbon |
|---|---|---|---|---|---|---|
| | | | Modu- | | | Fiber |
| | | Treat- | lus | Strength | Deflec- | Pinning |
| Composition | % | ment | (mPa) | (mPa) | tion (%) | ability |
| ACMO/ | 40/60 | no PC | 4624 | 171 | 8% | Good |
| M370 | | PC | 4289 | 159 | 5% | |
| ACMO/ | 40/60 | no PC | 2994 | 111 | 8% | Very Good |
| M2370 | | PC | 4728 | 175 | 6% | |

### Example 3. Exemplary Curable Composition with Tg>200° C.

50% ACMO
35% SR833S (tricyclodecane dimethanol diacrylate)
15% SR368 (isocyanurate triacrylate)
0.5% Omnirad 819 (bis-acyl phosphine oxide (BAPO))

This composition exhibited low warpage (by visual inspection) and greater than 3-month stability at 25° C. For an assessment of warping, between 15-20 layers were cured at one at a time on top of each other with a conveyer rigid. The part was about 12 inches long. When removed from the granite slab, the part was allowed to warp. By pressing down on one end, the other would lift. This measure of lift was compared across various formulations.

### Example 4. Application of 3-Prong Analysis on Various Acrylates/Acrylamides

Various (meth)acrylates and (meth)acrylamides were tested for inclusion in the curable compositions of the invention based on the results of the 3-prong analysis. Only compounds that exhibited triple plusses (+++) were considered for use as fast monomers—i.e., monomers that exhibited fast curing times.

T-8. Results of 3-prong evaluation of various
(meth)acrylates/(meth)acrylamides

| | Prong | Prong | Prong |
|---|---|---|---|
| (meth)acrylate/(meth)acrylamide | 1^{a} | 2^{b} | 3^{c} |
| glycerol carbonate acrylate | + | + | + |
| ACMO | + | + | + |
| 2-acrylamido-2-methyl- | − | + | + |
| propanesulfonic acid | | | |
| N-tert-butylacrylamide | − | − | + |
| diacetone acrylamide | − | − | + |
| N,N-diethylacrylamide | + | + | + |
| N,N-dimethylacrylamide | + | + | + |
| N-ethylacrylamide | + | + | + |
| N-[3-(dimethylamino)propyl]- | + | + | + |
| methacrylamide | | | |
| N,N′-hexamethylenebis- | + | + | + |
| (methacrylamide) | | | |
| N,-hydroxyethylacrylamide | + | + | + |
| (2-hydroxyphenyl)methacrylamide | | + | |
| 2-hydroxypropyl methacrylamide | + | + | + |
| N-(isobutoxymethyl)acrylamide | + | + | + |
| N-isopropylacrylamide | − | + | + |
| N-isopropylmethacrylamide | − | + | + |
| acrylamide | + | + | + |
| methacrylamide | + | + | + |
| N-(3-methoxypropyl)acrylamide | + | + | + |
| N-phenylacrylamide | − | + | + |
| dimethylaminoethyl methacrylate | + | − | + |
| N-3-dimethylaminopropyl methacrylate | + | − | + |
| acrylic acid | − | − | − |
| methacrylic acid | − | − | − |
| ethoxylated bisphenol A dimethacrylate | + | − | + |
| allyl methacrylate | + | − | − |
| tetrahydrofurfuryl methacrylate | + | + | − |
| triethylene glycol dimethacrylate | + | − | + |
| ethylene glycol dimethacrylate | + | − | + |
| 1,3-butylene glycol diacrylate | + | + | + |
| 1,4-butanediol diacrylate | + | − | + |
| 1,4-butanediol dimethacrylate | + | − | − |
| cycloaliphatic acrylate | − | + | − |
| diethylene glycol dimethacrylate | + | − | + |
| 1,6 hexanediol diacrylate | + | − | + |
| 1,6 hexanediol dimethacrylate | + | − | + |
| isodecyl methacrylate | + | − | + |
| neopentyl glycol diacrylate | − | + | + |
| neopentyl glycol dimethacrylate | − | − | + |
| polyethylene glycol (600) dimethacrylate | + | − | + |
| 2(2-ethoxyethoxy) ethyl acrylate | + | − | + |
| polyethylene glycol (200) diacrylate | + | − | + |
| tetraethylene glycol diacrylate | + | + | + |
| triethylene glycol diacrylate | + | − | + |
| DEG methyl ether acrylate | + | − | + |
| tetra hydrofurfuryl acrylate | + | + | + |
| 1,3-butylene glycol dimethacrylate | + | + | + |
| tripropylene glycol diacrylate | + | − | + |
| lauryl acrylate | + | − | − |
| 2-phenoxyethyl acrylate | + | − | + |
| 2-phenoxyethyl methacrylate | + | − | − |
| 2-phenoxyethyl methacrylate | + | − | + |
| methyl pentanediol diacrylate | + | + | + |
| polyethylene glycol (400) diacrylate | + | − | + |
| ethoxylated (2) bisphenol A | + | − | + |
| dimethacrylate | | | |
| trimethylolpropane trimethacrylate | + | − | + |
| di-trimethylolpropane tetraacrylate | − | + | + |
| trimethololpropane triacrylate | − | + | + |
| tris(2-hydroxy ethyl) isocyanurate | + | + | + |
| triacrylate | | | |
| glycidyl methacrylate | + | + | − |
| isodecyl acrylate | + | − | − |
| cyclohexane dimethanol diacrylate | − | − | + |
| 3,3,5-trimethyl cyclohexyl acrylate | − | − | − |
| 3,3,5-trimethylcyclohexanol MA | − | − | − |
| isobornyl methacrylate | − | − | − |
| pentaerythritol triacrylate | − | + | + |
| caprolactone acrylate | − | + | + |
| dipropylene glycol diacrylate | − | − | + |
| cyclic trimethylolpropane formal acrylate | − | − | + |
| triallyl isocyanurate | − | − | + |
| dicyclopentadienyl methacrylate | − | − | − |
| polyoxyethylene p-cumylphenyl ether | + | − | + |
| acrylate | | | |
| acrylate ester | + | − | + |
| NPG-hydroxypivaldehyde AA | − | + | + |
| aqueous zinc acrylate | − | − | − |
| metallic dimethacrylate | − | − | − |
| alkoxylated diacryate (PGMEA) | − | − | + |
| tricyclodecane dimethanol diacrylate | + | + | + |
| p-cumylphenyl acrylate | + | − | − |
| N-(2-acryloyloxyethyl)oxazolidinone | + | + | + |
| (HEOZA) | | | |
| glycerin carbonate methacrylate | + | + | + |
| 2-methylcyanoacrylate | + | − | + |
| hydroxyethyl methacrylate phosphate | + | + | + |
| hydroxyethyl acrylate phosphate | + | + | + |
| isopropylideneglycerol acrylate | + | − | + |
| isopropylideneglycerol methacrylate | + | − | + |

^{a}alpha/beta substitution prong restriction;
^{b}average dipole moment prong = 2.5 or more;
^{c}heteroatoms prong (acrylates = 3 or more/methacrylates = 4 or more/(meth)acrylamides = 2 or more)

### Example 5

The following entries in Table 9 represent exemplary curable compositions that are expected to be suitable for use in the invention as described herein. The listed weight percentages for each component (1, 2, 3 and 4) of Compositions A to K represent the amount of that component in a specific embodiment of that particular composition and are not intended to otherwise exclude other weight percentages that would be suitable for other embodiments.

T-9. Exemplary Curable Compositions

| | Component | Component | Component | Component | Photoinitiator |
|---|---|---|---|---|---|
| Composition | 1 (wt %) | 2 (wt %) | 3 (wt %) | 4 (wt %) | (4 wt %) |
| A | ACMO (48) | SR368 (38) | CN944 (10) | — | IRGACURE ® 819 |
| B | N-(3- | SR368 (29) | CN981 (14) | — | IRGACURE ® 819 |
| | methoxypropyl)- | | | | |
| | acrylamide (53) | | | | |
| C | ACMO (48) | SR368 (23) | SR212B (25) | — | IRGACURE ® 819 |
| D | ACMO (48) | SR368 (34) | SR833 (14) | — | IRGACURE ® 819 |
| E | — | SR368 (67) | SR833 (29) | — | IRGACURE ® 819 |
| F | ACMO (43) | SR368 (24) | CN9903 (24) | PMMA (5) | |
| G | N-(3- | SR368 (29) | hydroxyethylene | | IRGACURE ® 819 |
| | methoxypropyl)- | | urea methacrylate | | |
| | acrylamide (57) | | (10) | | |
| H | N,N- | SR368 (24) | CN963 (5) | Levamelt | IRGACURE ® 819 |
| | dimethylacrylamide | | | 700 (4) | |
| | (63) | | | | |
| I | GCMA (58) | SR368 (24) | HEOZA (14) | — | IRGACURE ® 819 |
| J | CD590 (48) | SR368 (48) | — | — | IRGACURE ® 819 |
| K | SR339 (60) | SR368 (26) | SR506 (10) | — | IRGACURE ® 819 |

GCMA = glycerol carbonate methacrylate
CD590 = ethoxylated (1) cumyl phenol acrylate
SR339 = 2-phenoxyethyl methacrylate
SR368 = trisisocyanurate triacrylate
CN944 = aliphatic urethane acrylate
SR212B = 1,3-butylene glycol diacrylate
SR833 = tricyclodecane dimethanol diacrylate
CN9903 = butylene urethane acrylate
HEOZA = N-(2-acryloyloxyethyl)oxazolidinone
SR506 = isobornyl acrylate
CN981 = aliphatic polyester/polyether urethane acrylate
CN963 = aliphatic polyester acrylate
Levamelt 700 = ethylene-vinyl acetate copolymer

1. An actinically curable composition comprising:
(a) 20 to 80 wt % of at least one monomer of formula (I); 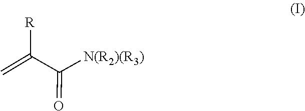
(b) 10 to 60 wt % of at least one monomer of formula (II); 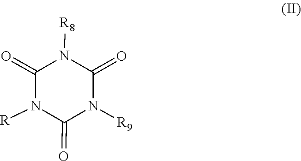
(c) 0 to 30 wt % of a urethane (meth)acrylate oligomer; and
(d) 0.1 to 5 wt % of a photoinitiator,
wherein:
R₁ is H or C₁-C₃ alkyl;
R₂ and R₃ are each independently selected from the group consisting of H, C₁-C₃ alkyl, CH₂—CH(OH)C₁-C₃ alkyl and (CH₂)ₘX,
or R₂ and R₃ together with the nitrogen atom to which they are attached form a 3- to 6-membered saturated heterocyclic ring;
X is OR₄, SR₄, NR₅R₆, OP(═O)(OR₄)₂, CH₂P(═O)(OR₄)₂ or an aromatic group;
each R₄ is independently selected from the group consisting of H and C₁-C₄ alkyl;
R₅ and R₆ are each independently selected from the group consisting of H and C₁-C₃ alkyl;
m is 1, 2, 3, 4 or 5;
R₇, R₈ and R₉ are each independently —(CH₂)ₙO(C═O)—CR₁₀═CH₂ or H, where at least two of R₇, R₈ and R₉ are —(CH₂)ₙO(C═O)—CR₁₀═CH₂;
R₁₀ is selected from the group consisting of H and C₁-C₃ alkyl; and
n is 1, 2, 3 or 4.

2. The curable composition according to claim 1, wherein for formula (I) R₁ is H, and R₂ and R₃ together with the nitrogen atom to which they are attached form a 5- or 6-membered saturated heterocyclic ring.

3. (canceled)

4. The curable composition according to claim 1, wherein for formula (II) at least two of R₇, R₈ and R₉ is (CH₂)ₙO(C═O)—CR₁₀═CH₂ where n is 2.

5. (canceled)

6. The curable composition according to claim 1, wherein for formula (II) at least two of R₇, R₈ and R₉ is (CH₂)ₙO(C═O)—CR₁₀═CH₂ where n is 2 and R₁₀ is H.

7. The curable composition according to claim 1, wherein the monomer of formula (I) is selected from the group consisting of:

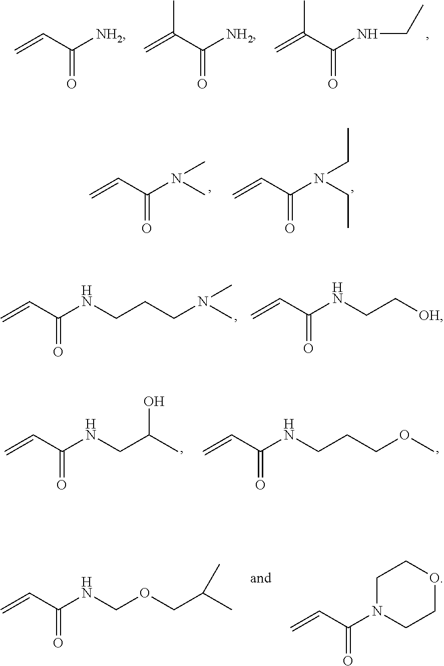

8. The curable composition according to claim 1, wherein the monomer of formula (I) is acryloyl morpholine

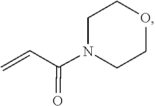

9. The curable composition according to claim 1, wherein the monomer of formula (II) is tris(2-hydroxyethyl)isocyanurate triacrylate

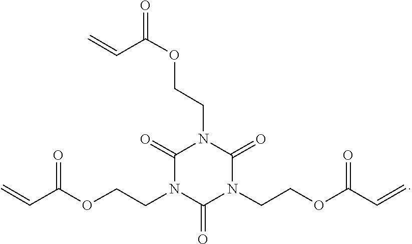 [SMILES: C=CC(=O)OCCn1c(=O)n(CCOC(=O)C=C)c(=O)n(CCOC(=O)C=C)c1=O]

10. The curable composition according to claim 1, wherein the monomer of formula (I) is acryloyl morpholine 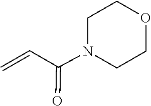
and the monomer of formula (II) is tris(2-hydroxyethyl)isocyanurate triacrylate

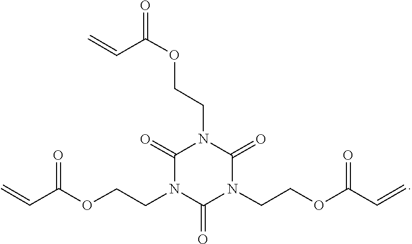 [SMILES: C=CC(=O)OCCn1c(=O)n(CCOC(=O)C=C)c(=O)n(CCOC(=O)C=C)c1=O]

11. The curable composition according to claim 1, further comprising a reinforcement material.

12. The curable composition according to claim 11, wherein the reinforcement material is selected from the group consisting of fiberglass, chopped carbon fibers, continuous carbon fibers and Kevlar, optionally in the presence of one or more of nylon, polylactic acid (PLA), acrylonitrile butadiene styrene (ABS), polyethylene terephthalate glycol (PETG) and polycarbonate.

13. (canceled)

14. The curable composition according to claim 12, wherein the reinforcement material is continuous carbon fibers.

15. The curable composition according to claim 1, wherein the urethane (meth)acrylate oligomer is present.

16.-17. (canceled)

18. The curable composition according to claim 1, further comprising a monomer of formula (III) 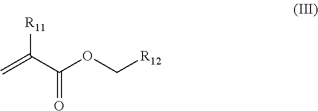
wherein:
each R₁₁ is independently H or C₁-C₃ alkyl; and
R₁₂ is selected from the group consisting of:
a 3- to 7-membered heterocyclic ring containing at least one of N, O or S when Ru is H and a 4- to 7-membered heterocyclic ring containing at least two of N, O or S when Ru is C₁-C₃ alkyl;
an optionally branched C₂-C₁₀ alkane chain wherein at least one carbon atom of the alkane chain is replaced by N, O, S or P when Ru is H, the alkane chain terminating in a C₁-C₃ alkyl group and where the optional branching group is a C₁-C₃ alkyl group;
an optionally branched C₃-C₁₀ alkane chain wherein at least two carbon atoms of the alkane chain is replaced by N, O, S or P when Ru is C₁-C₃ alkyl, the alkane chain terminating in a C₁-C₃ alkyl group and where the optional branching group is a C₁-C₃ alkyl group; and
an optionally branched C₂-C₂₀ alkane chain wherein one or more carbon atoms of the alkane chain are optionally replaced by N, O, S or P, the alkane chain terminating in a acrylate group (—O—C(═O)—CH═CH₂) or a methacrylate group (—O—C(═O)—C(CH₃)═CH₂) and where the optional branching group is a C₁-C₃ alkyl group.

19. (canceled)

20. The curable composition according to claim 1, comprising:
20-50 wt % acryloyl morpholine as monomer (I);
30-60 wt % tris(2-hydroxyethyl)isocyanurate triacrylate as monomer (II);
5-20 wt % of the urethane (meth)acrylate oligomer; and
0.1-5 wt % of the photoinitiator.

21.-22. (canceled)

23. A method of making a three dimensionally printed carbon bonded composite article using continuous fiber 3D, comprising:
irradiating the actinically curable composition according to claim 1, wherein the actinically curable composition further comprises continuous carbon fibers to form a cured three dimensionally printed carbon bonded composite article.

24. A method of making a three dimensionally printed composite article comprising:
discharging the actinically curable composition according to claim 1 from a print head, wherein the actinically curable composition further comprises reinforcement material;
moving the print head during discharging the actinically curable composition; and
irradiating the actinically curable composition to form a cured three dimensionally printed composite article.

25. The method according to claim 23, wherein the composition is applied as a single deposition.

26.-27. (canceled)

28. A print head containing the curable composition according to claim 1.

29. The curable composition according to claim 1, wherein:
all three of R₇, R₈ and R₉ is (CH₂)ₙO(C═O)—CR₁₀═CH₂ where n is 1, 2, 3, or 4;
all three of R₇, R₈ and R₉ is (CH₂)ₙO(C═O)—CR₁₀═CH₂ where n is 1, 2, 3, or 4, and R₁₀ is H; or
all three of R₇, R₈ and R₉ is (CH₂)ₙO(C═O)—CR₁₀═CH₂ where n is 1, 2, 3, or 4, and R₁₀ is CH₃.

30. The curable composition according to claim 1, wherein a cured composite article prepared from the curable composition has a Tg of at least 130° C.
